(19) United States
(12) Patent Application Publication
(10) Pub. No.: US 2023/0343968 A1
(43) Pub. Date: Oct. 26, 2023

(54) ANODES FOR LITHIUM-BASED ENERGY STORAGE DEVICES

(71) Applicant: Graphenix Development, Inc., Williamsville, NY (US)

(72) Inventors: John C. BREWER, Rochester, NY (US); Alexander J. WARREN, Lake View, NY (US); Kevin TANZIL, Rochester, NY (US); Paul D. GARMAN, Pitsford, NY (US); Robert G. ANSTEY, Tonawanda, NY (US); Kyle P. POVLOCK, Fairport, NY (US)

(73) Assignee: Graphenix Development, Inc., Williamsville, NY (US)

(21) Appl. No.: 18/010,737

(22) PCT Filed: Jun. 28, 2021
(86) PCT No.: PCT/US2021/039426

§ 371 Date: Dec. 15, 2022

Related U.S. Application Data
(60) Provisional application No. 63/179,971, filed on Apr. 26, 2021.
(60) Provisional application No. 63/045,570, filed on Jun. 29, 2020.

(51) Int. Cl. H01M 4/66; H01M 10/0525; H01M 4/62; H01M 4/75

(52) U.S. Cl. CPC H01M 4/667; H01M 4/625; H01M 4/626; H01M 4/662; H01M 4/75; H01M 10/0525

(57) ABSTRACT

An anode for an energy storage device includes a current collector having an electrically conductive layer and a surface layer disposed over the electrically conductive layer. The surface layer may include a first surface sublayer proximate the electrically conductive layer and a second surface sublayer disposed over the first surface sublayer. The first surface sublayer may include zinc. The second surface sublayer may include a metal-oxygen compound, wherein the metal-oxygen compound includes a transition metal other than zinc. The current collector may be characterized by a surface roughness Rₐ ≥ 250 nm. The anode further includes a continuous porous lithium storage layer overlaying the surface layer. The continuous porous lithium storage layer may have an average thickness of at least 7 µm, may include at least 40 atomic % silicon, germanium, or a combination thereof, and may be substantially free of carbon-based binders.

### CROSS-REFERENCES TO RELATED APPLICATIONS

This application claims the benefit of priority of U.S. Provisional Application No. 63/045,570, filed Jun. 29, 2020 and U.S. Provisional Application No. 63/179,971, filed Apr. 26, 2021, each of which is incorporated herein by reference in its entirety.

### TECHNICAL FIELD

The present disclosure relates to lithium-ion batteries and related energy storage devices.

### BACKGROUND

Silicon has been proposed for lithium-ion batteries to replace the conventional carbon-based anodes, which have a storage capacity that is limited to ~370 mAh/g. Silicon readily alloys with lithium and has a much higher theoretical storage capacity (~3600 to 4200 mAh/g at room temperature) than carbon anodes. However, insertion and extraction of lithium into the silicon matrix causes significant volume expansion (>300%) and contraction. This can result in rapid pulverization of the silicon into small particles and electrical disconnection from the current collector.

The industry has recently turned its attention to nano- or micro-structured silicon to reduce the pulverization problem, i.e., silicon in the form of spaced apart nano- or micro-wires, tubes, pillars, particles, and the like. The theory is that making the structures nano-sized avoids crack propagation and spacing them apart allows more room for volume expansion, thereby enabling the silicon to absorb lithium with reduced stresses and improved stability compared to, for example, macroscopic layers of bulk silicon.

Despite research into various approaches, batteries based primarily on silicon have yet to make a large market impact due to unresolved problems.

### SUMMARY

There remains a desire for anodes for lithium-based energy storage devices such as Li-ion batteries that are easy to manufacture, robust to handling, high in charge capacity amenable to fast charging, for example, at least 1C, and that are resistant to dimensional changes.

In accordance with an embodiment of this disclosure, an anode for an energy storage device includes a current collector having an electrically conductive layer and a surface layer disposed over the electrically conductive layer. The surface layer may include a first surface sublayer proximate the electrically conductive layer and a second surface sublayer disposed over the first surface sublayer. The first surface sublayer may include zinc. The second surface sublayer may include a metal-oxygen compound, wherein the metal-oxygen compound includes a transition metal other than zinc. The current collector may be characterized by a surface roughness Ra ≥ 250 nm. The anode further includes a continuous porous lithium storage layer overlaying the surface layer. The continuous porous lithium storage layer may have an average thickness of at least 7 µm, may include at least 40 atomic % silicon, germanium, or a combination thereof, and may be substantially free of carbon-based binders.

The present disclosure provides anodes for energy storage devices that may have one or more of at least the following advantages relative to conventional anodes: improved stability at aggressive ≥1C charging rates; higher overall areal charge capacity; higher charge capacity per gram of lithium storage material (e.g., silicon); improved physical durability; simplified manufacturing process; more reproducible manufacturing process; or reduced dimensional changes during operation.

### BRIEF DESCRIPTION OF DRAWINGS

FIG. 1 is a cross-sectional view of a non-limiting example of an anode according to some embodiments.

FIG. 2 is a cross-sectional view of a prior art anode.

FIG. 3 is a cross-sectional view of a non-limiting example of an anode according to some embodiments.

FIG. 4 is a cross-sectional view of a non-limiting example of an anode according to some embodiments.

FIG. 5A is a cross-sectional view of a non-limiting example of a current collector having first-type nanopillars according to some embodiments.

FIG. 5B is a cross-sectional view of a non-limiting example of a current collector having second-type nanopillars according to some embodiments.

FIG. 5C is an SEM cross-sectional view of a non-limiting example of a current collector having broad roughness features according to some embodiments.

FIG. 6 is a cross-sectional view of a non-limiting example of an anode according to some embodiments.

FIG. 7 is a cross-sectional SEM of example anode E-1A.

FIG. 8A is a top-down SEM view of the current collector used in example E-14B.

FIG. 8B is a cross-sectional SEM of the current collector used in example E-14B.

FIG. 8C is a cross-sectional SEM of the anode of example E-14B.

FIG. 9 is a cross-sectional SEM of the current collector used in example E-16B.

FIG. 10A is a 45-degree SEM perspective view of the current collector used in example E-14B.

FIG. 10B is a cross-sectional SEM of the current collector used in example E-14B.

FIG. 10C is a cross-sectional SEM of the anode of example E-14B.

FIG. 11 is a 45-degree SEM perspective view of the current collector used in example E-3B.

### DETAILED DESCRIPTION

It is to be understood that the drawings are for purposes of illustrating the concepts of the disclosure and may not be to scale. Terms like “overlaying”, “over” or the like do not necessarily mean direct contact unless such direct contact is noted or clearly required for functionality. However, embodiments of “overlaying” or “over” may include layers that are in direct contact.

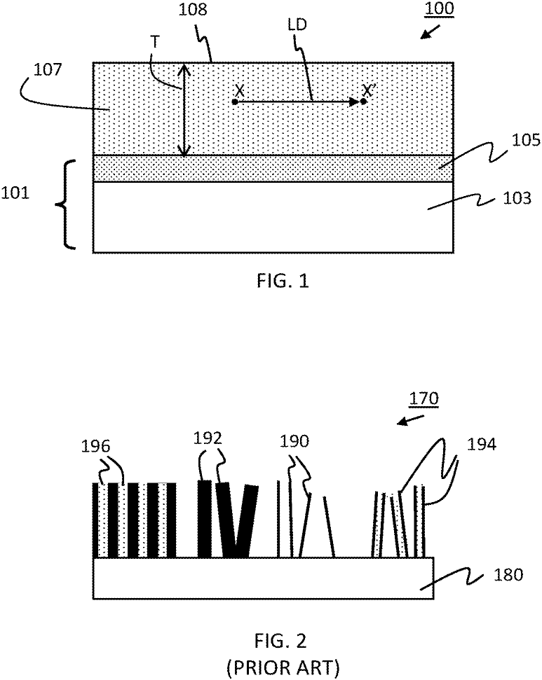

FIG. 1 is a cross-sectional view of an anode according to some embodiments of the present disclosure. Anode 100 includes current collector 101 and a continuous porous lithium storage layer 107 overlaying the current collector. Current collector 101 includes a surface layer 105 provided over an electrically conductive layer 103, for example an electrically conductive metal layer. Although the figure shows the surface of the current collector as flat for convenience, the current collector may have a rough surface as discussed below. The continuous porous lithium storage layer 107 is provided over surface layer 105. In some embodiments, the top of the continuous porous lithium storage layer 107 corresponds to a top surface 108 of anode 100. In some embodiments the continuous porous lithium storage layer 107 is in physical contact with the surface layer 105. In some embodiments the continuous porous lithium storage layer includes a material capable of forming an electrochemically reversible alloy with lithium. In some embodiments, the continuous porous lithium storage layer includes silicon, germanium, tin, or alloys thereof. In some embodiments the continuous porous lithium storage layer comprises at least 40 atomic % silicon, germanium, or a combination thereof. In some embodiments, the continuous porous lithium storage layer is provided by a chemical vapor deposition (CVD) process including, but not limited to, hot-wire CVD or a plasma-enhanced chemical vapor deposition (PECVD).

In the present disclosure, the continuous porous lithium storage layer is substantially free of high aspect ratio nanostructures, e.g., in the form of spaced-apart wires, pillars, tubes or the like, or in the form of regular, linear vertical channels extending through the lithium storage layer. FIG. 2 shows a cross-sectional view of a prior art anode 170 that includes some non-limiting examples of lithium storage nanostructures, such as nanowires 190, nanopillars 192, nanotubes 194 and nanochannels 196 provided over a current collector 180. Unless noted otherwise, the term ″lithium storage nanostructure″ herein generally refers to a lithium storage active material structure (for example, a structure of silicon, germanium or their alloys) having at least one cross-sectional dimension that is less than about 2,000 nm, other than a dimension approximately normal to an underlying substrate (such as a layer thickness) and excluding dimensions caused by random pores and channels. Similarly, the terms ″nanowires″, ″nanopillars″ and ″nanotubes″ refers to wires, pillars and tubes, respectively, at least a portion of which, have a diameter of less than 2,000 nm. ″High aspect ratio″ nanostructures have an aspect ratio greater than 4:1, where the aspect ratio is generally the height or length of a feature (which may be measured along a feature axis aligned at an angle of 45 to 90 degrees relative to the underlying current collector surface) divided by the width of the feature (which may be measured generally orthogonal to the feature axis). In some embodiments, the continuous porous lithium storage layer is considered ″substantially free″ of lithium storage nanostructures when the anode has an average (e.g., mean, median, or mode) of fewer than 10 lithium storage nanostructures per 1600 square micrometers (in which the number of lithium storage nanostructures is the sum of the number of nanowires, nanopillars, and nanotubes in the same unit area), such lithium storage nanostructures having an aspect ratio of 4:1 or higher. Alternatively, there is an average of fewer than 1 such lithium storage nanostructures per 1600 square micrometers. As noted below, the current collector may have a high surface roughness or include nanostructures, but these features are separate from the continuous porous lithium storage layer and different than lithium storage nanostructures.

In some embodiments, deposition conditions are selected in combination with the current collector so that the continuous porous lithium storage layer is relatively smooth providing an anode with diffuse or total reflectance of at least 10% at 550 nm, alternatively at least 20% (measured at the continuous porous lithium storage layer side). In some embodiments, anodes having such diffuse or total reflectance may be less prone to damage from physical handling. In some embodiments, anodes that are not substantially free of lithium storage nanostructure may have lower reflectance and may be more prone to damage from physical handling.

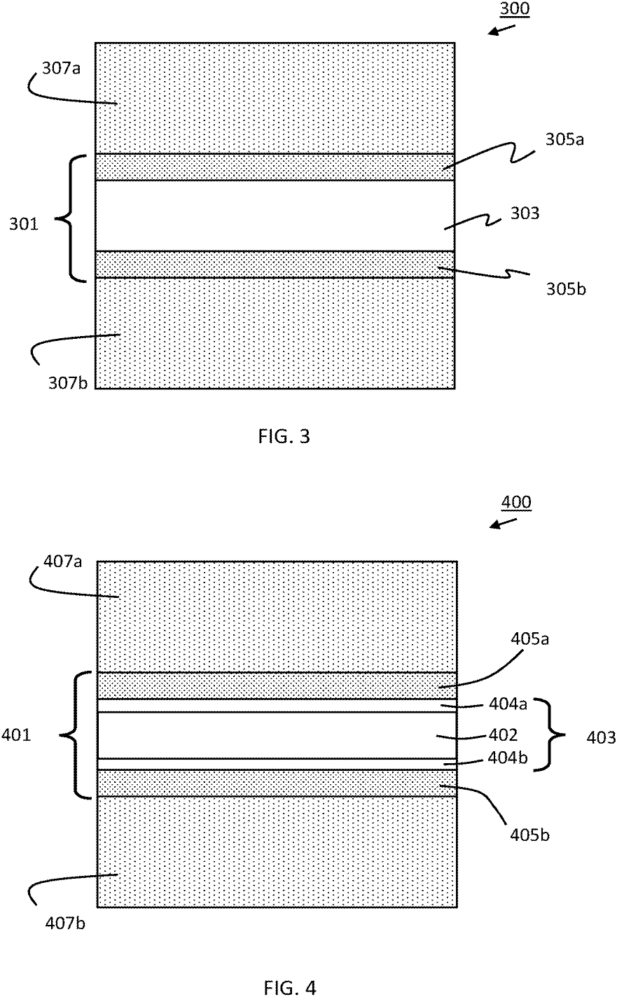

Anodes of the present disclosure may optionally be two-sided. For example, FIG. 3 is a cross-sectional view of a two-sided anode according to some embodiments. The current collector 301 may include electrically conductive layer 303 and surface layers (305a, 305b) provided on either side of the electrically conductive layer 303. Continuous porous lithium storage layers (307a, 307b) are disposed on both sides to form anode 300. Surface layers 305a and 305b may be the same or different with respect to composition, thickness, roughness or some other property. Similarly, continuous porous lithium storage layers 307a and 307b may be the same or different with respect to composition, thickness, porosity or some other property.

### Current Collector

In some embodiments, the current collector or the electrically conductive layer may be characterized by a tensile strength Rm or a yield strength Re. In some cases, the tensile and yield strength properties of the current collector are dependent primarily on the electrically conductive layer, which in some embodiments, may be thicker than the surface layer. If the tensile strength is too high or too low, it may be difficult to handle in manufacturing such as in roll-to-roll processes. During electrochemical cycling of the anode, deformation of the anode may occur if the tensile strength is too low, or alternatively, adhesion of the continuous porous lithium storage layer may be compromised if the tensile strength is too high.

Deformation of the anode is not necessarily a problem for all products, and such deformation may sometimes only occur at higher capacities, i.e., higher loadings of lithium storage layer material. For such products, the current collector or electrically conductive layer may be characterized by a tensile strength Rₘ in a range of 100 - 150 MPa, alternatively 150 -200 MPa, alternatively 200 - 250 MPa, alternatively 250 - 300 MPa, alternatively 300 - 350 MPa, alternatively 350 - 400 MPa, alternatively 400 - 500 MPa, alternatively 500 - 600 MPa, alternatively 600 - 700 MPa, alternatively 700 - 800 MPa, alternatively 800 - 900 MPa, alternatively 900 - 1000 MPa, alternatively 1000 - 1200 MPa, alternatively 1200 - 1500 MPa, or any combination of ranges thereof.

In some embodiments, significant anode deformation should be avoided, but low battery capacities may not be acceptable. For example, when the anode includes 7 µm or more of amorphous silicon and/or the electrochemical cycling capacity is 1.5 mAh/cm² or greater, the current collector or electrically conductive layer may be characterized by a tensile strength Rₘ of greater than 600 MPa. In such embodiments, the tensile strength may be in a range of 601 - 650 MPa, alternatively 650 - 700 MPa, alternatively 700 - 750 MPa, alternatively 750 - 800 MPa, alternatively 800 - 850 MPa, alternatively 850 - 900 MPa, alternatively 900 - 950 MPa, alternatively 950 - 1000 MPa, alternatively 1000 - 1200 MPa, alternatively 1200 - 1500 MPa, or any combination of ranges thereof. In some embodiments, the current collector or electrically conductive layer may have a tensile strength of greater than 1500 MPa. In some embodiments, the current collector or electrically conductive layer is in the form of a foil having a tensile strength of greater than 600 MPa and an average thickness in a range of 4 - 8 µm, alternatively 8 - 10 µm, alternatively 10 - 15 µm, alternatively 10 - 15 µm, alternatively 15 - 20 µm, alternatively 20 - 25 µm, alternatively 25 - 30 µm, alternatively 30 - 40 µm, alternatively 40 -50 µm, or any combination of ranges thereof.

In some embodiments the electrically conductive layer may have a conductivity of at least 10³ S/m, or alternatively at least 10⁶ S/m, or alternatively at least 10⁷ S/m, and may include inorganic or organic conductive materials or a combination thereof. For anodes having low capacity and/or where there are no concerns regarding anode deformation during use, a wide variety of conductive materials may be used as the electrically conductive layer.

In some embodiments, the electrically conductive layer includes a metallic material, e.g., titanium (and its alloys), nickel (and its alloys), copper (and its alloys), or stainless steel. In some embodiments, the electrically conductive layer includes an electrically conductive carbon, such as carbon black, carbon nanotubes, graphene, graphene oxide, reduced graphene oxide, and graphite. In some embodiments the electrically conductive layer may be in the form of a foil, a mesh, or sheet of conductive material. Herein, a “mesh” includes any electrically conductive structure having openings such as found in interwoven wires, foam structures, foils with an array of holes, or the like. In some embodiments, the electrically conductive layer may include multiple layers of different electrically conductive materials. The electrically conductive layer may be in the form of a layer deposited onto an insulating substrate (e.g., a polymer sheet or ceramic substrate coated with a conductive material, including but not limited to, nickel or copper, optionally on both sides). In some embodiments, the electrically conductive layer includes a mesh or sheet of electrically conductive carbon, including but not limited to, those formed from bundled carbon nanotubes or nanofibers.

When higher tensile strength is desirable, the electrically conductive layer may include nickel (and certain alloys), or certain copper alloys, such as brass (an alloy primarily of copper and zinc), bronze (an alloy primarily of copper and tin), CuMgAgP (an alloy primarily of copper, magnesium, silver, and phosphorous), CuFe2P (an alloy primarily of copper, iron, and phosphorous) CuNi3Si (an alloy primarily of copper, nickel, and silicon). The nomenclature for the metal alloys is not the stoichiometric molecular formula used in chemistry but rather the nomenclature used by those of ordinary skill in the alloy arts. For example, CuNi3Si does not mean there are three atoms of nickel and one atom of silicon for each atom of copper. In some embodiments these nickel- or copper-based higher tensile electrically conductive layers may include roll-formed nickel or copper alloy foils.

Alternatively, a mesh or sheet of electrically conductive carbon, including but not limited to, those formed from bundled carbon nanotubes or nanofibers, may provide higher tensile strength electrically conductive layers. In some embodiments, an electrically conductive metal interlayer may be interposed between the electrically conductive carbon and the surface layer.

In some embodiments, any of the above-mentioned electrically conductive layers (low or high tensile strength) may act as a primary electrically conductive layer and further include an electrically conductive interlayer, e.g., a metal interlayer, disposed between the primary electrically conductive layer and the surface layer. FIG. 4 is a cross-sectional view of such an anode according to some embodiments, in this case, for a two-sided anode. The current collector 401 may include electrically conductive layer 403 and surface layers (405a, 405b) provided on either side of the electrically conductive layer 403. Continuous porous lithium storage layers (407a, 407b) may be disposed on both sides to form anode 400. Electrically conductive layer 403 includes a primary electrically conductive layer 402 with metal interlayers (404a, 404b) provided on either side. Metal interlayers 404a and 404b may be the same or different with respect to composition, thickness, roughness, or some other property. Similarly, surface layers 405a and 405b may be the same or different with respect to composition, thickness, roughness or some other property. Similarly, continuous porous lithium storage layers 407a and 407b may be the same or different with respect to composition, thickness, porosity or some other property.

The metal interlayer may be applied by, e.g., by sputtering, vapor deposition, electrolytic plating or electroless plating, or any convenient method. The metal interlayer generally has an average thickness of less than 50% of the average thickness of the total electrically conductive layer, i.e., the combined thickness of primary electrically conductive layer and metal interlayer(s). In some embodiments, the surface layer may form more uniformly over, or adhere better to, the metal interlayer than to the primary electrically conductive layer.

In some embodiments, the current collector may be characterized as having a surface roughness. In some embodiments, the top surface 108 of the lithium storage layer 107 may have a lower surface roughness than the surface roughness of current collector 101. Herein, surface roughness comparisons and measurements may be made using the Roughness Average (Ra), RMS Roughness (R_{q}), Maximum Profile Peak Height roughness (Rₚ), Average Maximum Height of the Profile (R_{z}), or Peak Density (Pc). In some embodiments, the current collector may be characterized as having both a surface roughness R_{z} ≥ 2.5 µm and a surface roughness Ra ≥ 0.25 µm. In some embodiments, R_{z} is in a range of 2.5 - 3.0 µm, alternatively 3.0 - 3.5 µm, alternatively 3.5 - 4.0 µm, alternatively 4.0 - 4.5 µm, alternatively 4.5 - 5.0 µm, alternatively 5.0 - 5.5 µm, alternatively 5.5 - 6.0 µm, alternatively 6.0 - 6.5 µm, alternatively 6.5 - 7.0 µm, alternatively 7.0 - 8.0 µm, alternatively 8.0 - 9.0 µm, alternatively 9.0 to 10 µm, 10 to 12 µm, 12 to 14 µm or any combination of ranges thereof. In some embodiments, Ra is in a range of 0.25 -0.30 µm, alternatively 0.30 - 0.35 µm, alternatively 0.35 - 0.40 µm, alternatively 0.40 - 0.45 µm, alternatively 0.45 - 0.50 µm, alternatively 0.50 - 0.55 µm, alternatively 0.55 - 0.60 µm, alternatively 0.60 - 0.65 µm, alternatively 0.65 - 0.70 µm, alternatively 0.70 - 0.80 µm, alternatively 0.80 - 0.90 µm, alternatively 0.90 - 1.0 µm, alternatively 1.0 - 1.2 µm, alternatively 1.2 - 1.4 µm, or any combination of ranges thereof.

In some embodiments, some or most of the surface roughness of the current collector may be imparted by the electrically conductive layer and/or a metal interlayer. Alternatively, some or most of the surface roughness of the current collector may be imparted by the surface layer. Alternatively, some combination of the electrically conductive layer, metal interlayer, and surface layer may contribute substantially to the surface roughness.

In some embodiments, the electrically conductive layer, e.g., the metal interlayer, may include electrodeposited copper roughening features to increase surface roughness. For instance, a relatively smooth copper foil may be provided into a first acid copper plating solution having 50 to 250 g/L of sulfuric acid and less than 10 g/L copper provided as copper sulfate. Copper features may be deposited at room temperature by cathodic polarization of the copper foil and applying a current density of about 0.05 to 0.3 A/cm² for a few seconds to a few minutes. In some embodiment, the copper foil may next be provided into a second acid copper plating solution having 50 to 200 g/L of sulfuric acid and greater than 50 g/L copper provided as copper sulfate. The second acid copper bath may optionally be warmed to temperature of about 30° C. to 50° C. A thin copper layer may be electroplated at over the copper features to secure the particles to the copper foil by cathodic polarization and applying a current density of about 0.05 to 0.2 A/cm² for a few seconds to a few minutes.

Alternatively, or in combination with the electrodeposited copper roughening features, the electrically conductive layer may undergo another electrochemical, chemical or physical treatment to impart a desired surface roughness prior to formation of the surface layer.

In some embodiments, a metal foil, including but not limited to, a rolled copper foil, may be first heated in an oven in air (e.g., between 100° and 200° C.) for a period of time (e.g., from 10 minutes to 24 hours) remove any volatile materials on its surface and cause some surface oxidation. In some embodiments, the heat-treated foil may then be subjected to additional chemical treatments, e.g., immersion in a chemical etching agent such as an acid or a hydrogen peroxide/HCl solution optionally followed by deionized water rinse. The chemical etching agent removes oxidized metal. Such treatment may increase the surface roughness. In some embodiments, there is no heating, but a treatment with a chemical etching agent that includes an oxidant. In some embodiments, the oxidant may be dissolved oxygen, hydrogen peroxide, or some other appropriate oxidant. Such chemical etching agents may further include an organic acid such as methanesulfonic acid or an inorganic acid such as hydrochloric or sulfuric acid. A chemical etching agent may optionally be followed by deionized water rinse. Such treatments described in this paragraph may be referred to herein as “chemical roughening” treatments. In the case of copper foils, any chemical roughening treatment performed in ambient is expected to form at least a monolayer of a copper oxide after rinsing and drying. Such copper oxide (or other metal oxide) surface may be appropriately receptive to further treatments such as with silicon compound agents.

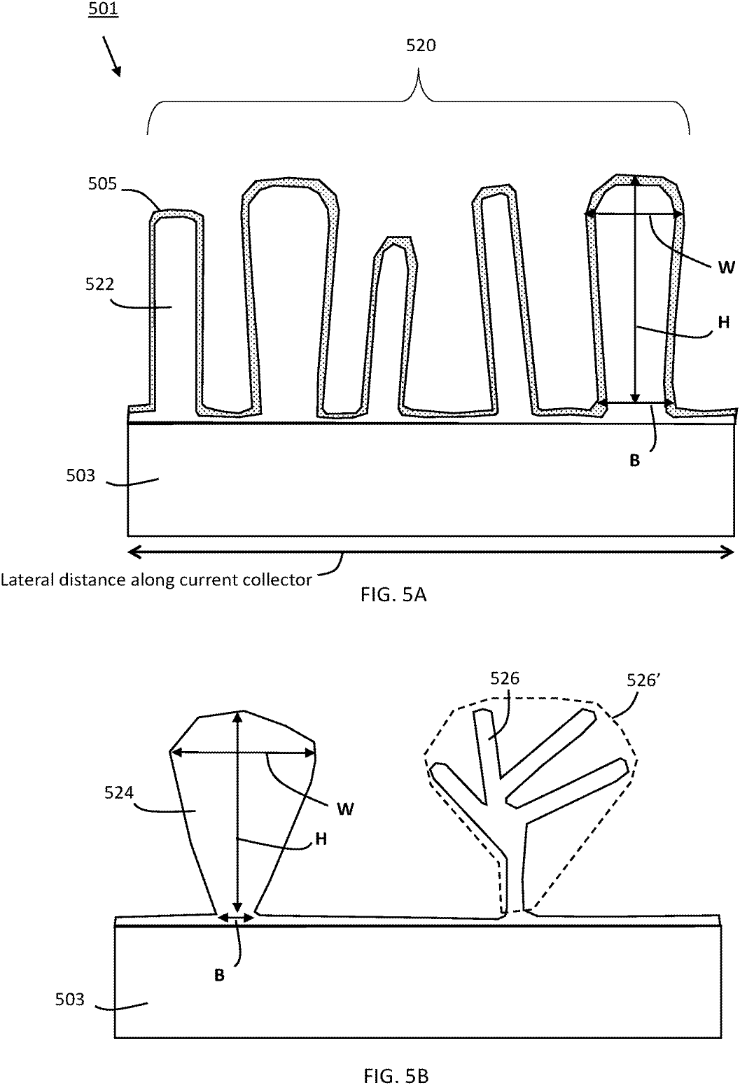

In some embodiments, the electrodeposited copper roughening features may be characterized as nanopillar features. FIG. 5A illustrates a cross-sectional view of a non-limiting example of electrodeposited copper roughening features according to some embodiments. In some cases, current collector 501 may include a plurality of nanopillar features 520 (electrodeposited copper roughening features) disposed over the electrically conductive layer 503. Nanopillar features 520 are distinguished from nanopillars 192 of FIG. 2 at least by their compositions, their layers, their dimensions, the processes used to form the nanopillars, their surface densities, and/or their orientations. Nanopillar features 520 may include a metal-containing nanopillar core 522 (e.g., copper-containing core) and a surface layer 505 provided at least partially over the nanopillar core and optionally over the electrically conductive layer in interstitial areas between nanopillar features. The nanopillar features may each be characterized by a height H, a base width B, and a maximum width W. The base width B may be the minimum width across the bottom or base of the nanopillar feature. The maximum width W may be measured across the widest section orthogonal to the nanopillar feature axis. The height H may be measured from the base to the end of the nanopillar feature along the nanopillar feature axis. The nanopillar axis is the longitudinal axis of the nanopillar feature. In some cases, the nanopillar feature axis may pass through the center of mass of the nanopillar feature

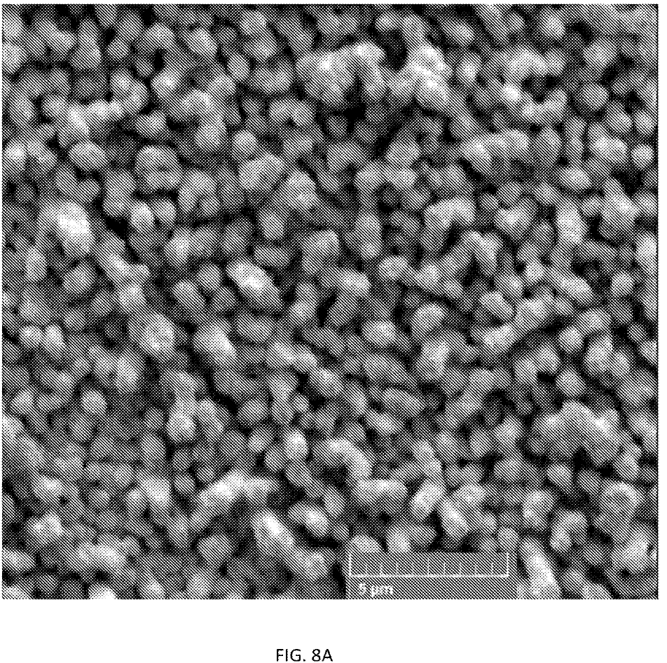

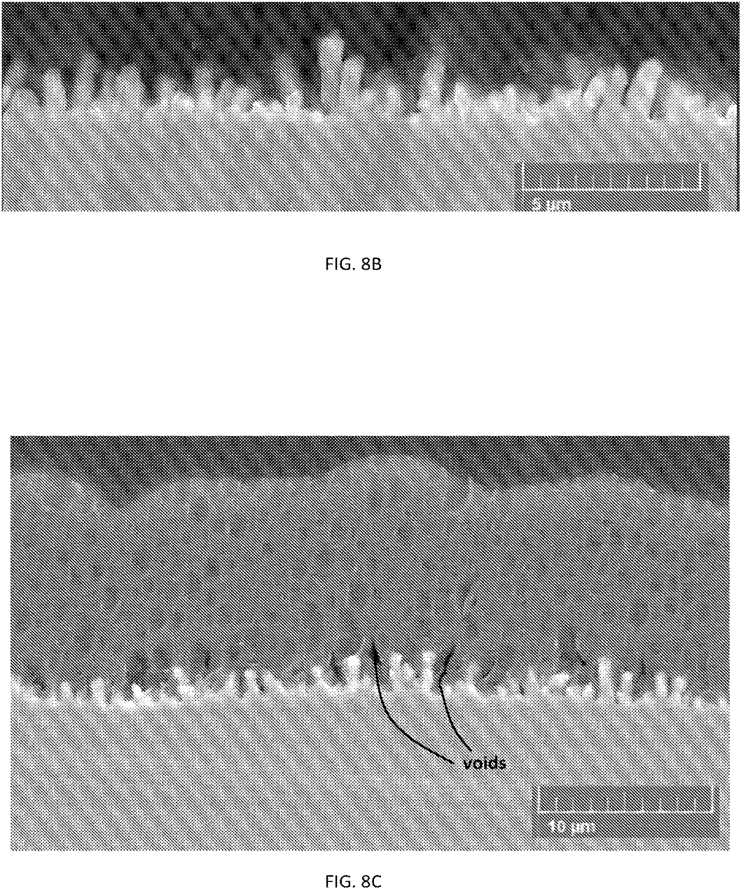

In some embodiments, nanopillar features may be characterized as first-type and second-type nanopillars. The second-type may be less desirable than the first-type. In some cases, first-type nanopillars may be characterized by: H in a range of 0.4 µm to 3.0 µm; B in a range of 0.2 µm to 1.0 µm; a W/B ratio in a range of 1 to 1.5; an H/B (aspect) ratio in a range of 0.8 to 4.0; and an angle of the longitudinal axis of the nanopillar feature to the plane of the electrically conductive layer in a range of 60° to 90°. For example, all of the nanopillar features in FIG. 5A may be first-type nanopillars. An SEM cross-section example may be found in FIGS. 8A and 8B which are discussed later. In some embodiments, in an optical or SEM analysis, an average 20 µm long cross section of the current collector may include at least two (2) first-type nanopillars, alternatively at least 3, at least 4, at least 5, at least 6, at least 7, at least 8, or at least 10 first-type nanopillars. In some embodiments, in an optical or SEM analysis, an average 20 µm long cross section of the current collector may include 2 - 4 first-type nanopillars, alternatively 4 - 6, alternatively 6 - 8, alternatively 8 - 10, alternatively 10 - 12, alternatively 12 - 14, alternatively 14 - 16, alternatively 16 - 20, alternatively 20 - 25, alternatively 25 - 30, or any combination of ranges thereof. Note that the 20 µm length of analysis refers to a lateral distance along the length of the current collector, for example, as indicated in FIG. 5A

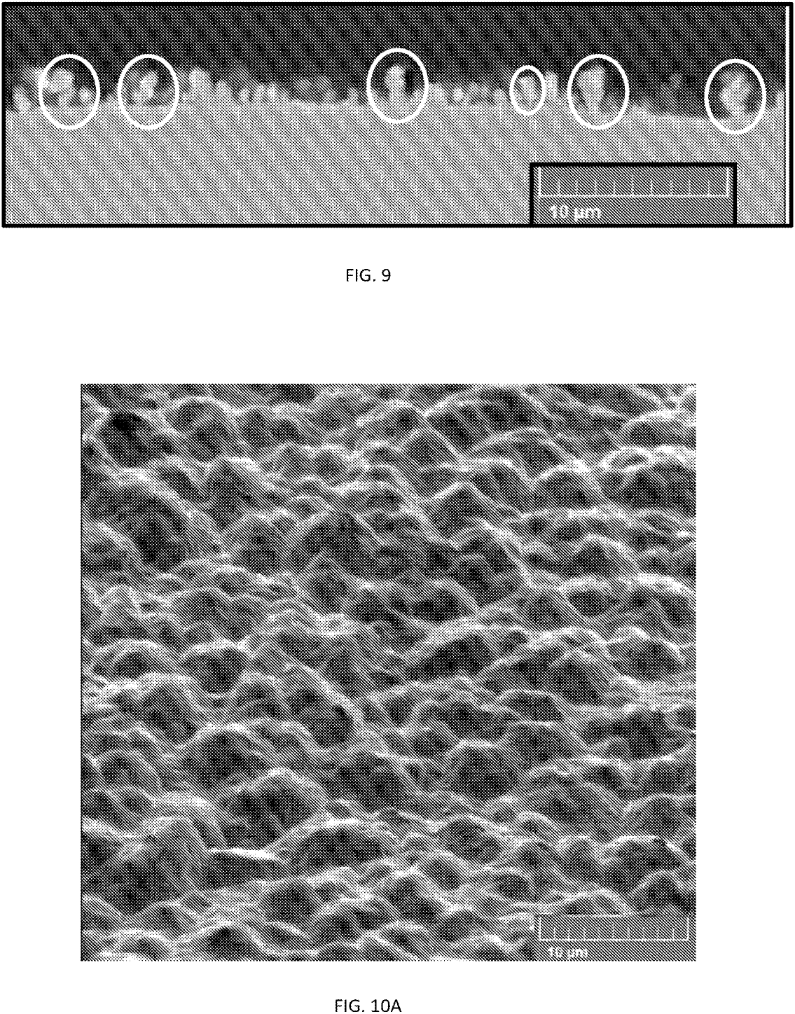

In some cases, second-type nanopillars may be characterized by H of at least 1.0 µm and a W/B ratio greater than 1.5. That is, second-type nanopillars tend to widen away from their base. An SEM cross-section example may be found in FIG. 9, which is discussed later. FIG. 5B is a cross-sectional view of a non-limiting example of second-type nanopillars. For clarity the nanopillar core and surface layers are not separately defined. A second-type nanopillar may have a significantly wide upper portion (sometimes referred to herein as ″wide-top roughening features″) such as nanopillar feature 524. Alternatively, a second-type nanopillar may include a branched or tree-like structure as in nanopillar feature 526. Although the ″trunk″ and ″branches″ are all similar in width, the feature overall is significantly wider toward the top as illustrated by effective cross section profile 526′. Effective cross section profile 526′ is a shape formed by lines drawn between the outermost points of consecutive branches or trunk of the nanopillar feature. Such branched structures may have the same effect as a solid nanopillar feature like 524. In some embodiments, in an optical or SEM analysis, an average 20 µm long cross section of the current collector may include fewer second-type nanopillars than first-type nanopillars. In some embodiments, in an optical or SEM analysis, an average 20 µm long cross section of the current collector may include fewer than four (4), alternatively fewer than 3, fewer than 2, or fewer than 1 second-type nanopillar.

In some embodiments, the surface roughness may be relatively large with respect to Rₐ or R_{z}, but the features themselves may be broad roughness features, e.g., as bumps and hills separated on average by at least about 2 µm microns. FIG. 5C is an SEM cross-sectional view of a portion of a current collector having broad roughness features. Current collector 501C includes electrically conductive layer 503C (the surface layer is not easy to make out in the SEM). This current collector had a measured surface roughness Ra = 508 nm. The broad roughness features may be characterized by a peak height P and a valley-to-valley separation V. The ratio P/V represents an aspect ratio of the broad roughness feature. In some embodiments, on average, V is greater than at least 3 µm or alternatively at least 4 µm, and P/V is less than 0.8, alternatively less than 0.6. In some embodiments, on average, V is in a range of 3 - 4 µm, alternatively 4 - 5 µm, alternatively 5 - 6 µm, alternatively 6 - 8 µm, alternatively, 8 - 10 µm, alternatively 10 - 12 µm, alternatively 12 - 15 µm, and P/V is in a range of 0.2 - 0.3, alternatively 0.3 - 0.4, alternatively 0.4 - 0.5, alternatively 0.5 - 0.6, alternatively 0.6 - 0.7, alternatively 0.7 - 0.8, or any combination of ranges thereof for V and P/V. In some embodiments, V is the same as the peak-to-peak separation. This same current collector is discussed later with respect to FIGS. 8A and 8B.

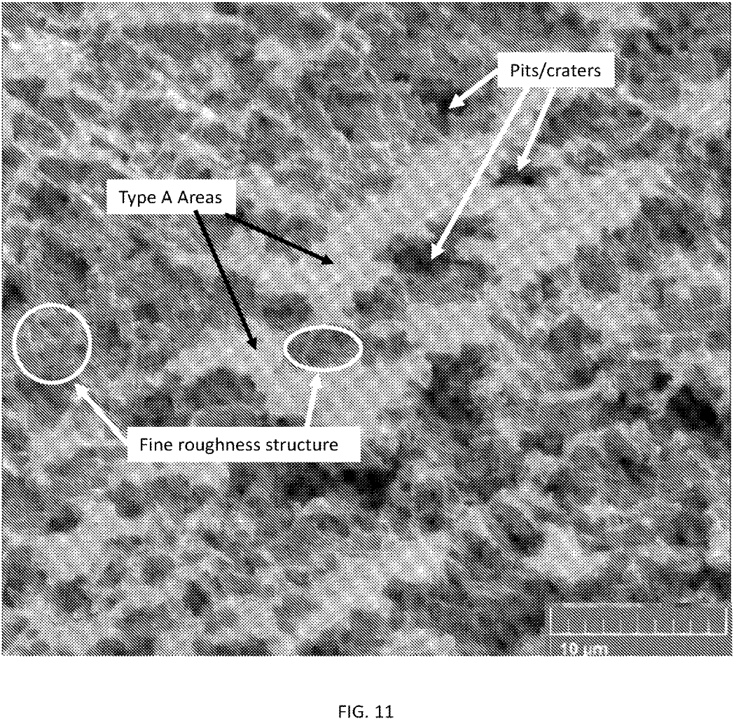

In some embodiments, chemically roughened current collector surfaces may appear pitted, cratered, or corroded. A non-limiting example is shown in FIG. 11. Some areas corresponding approximately to the original surface can still be seen such as in Type A areas -one can still make out lines from the original roll-formed surface. The majority of the surface has been etched leading to very rough, random, cratered topology that is much rougher than the original surface. In some embodiments, at least 50% of the surface of the electrically conductive layer has been etched to a depth of at least 0.5 µm from the original surface, alternatively at least 1.0 µm, wherein the surface roughness Rₐ is at least 400 nm, alternatively at least 500 nm, alternatively at least 600 nm, alternatively at least 700 nm. Numerous pits/craters are visible. In some embodiments when inspected by SEM analysis, an average 100 square micron area of a chemically roughened current collector may include at least 1 recognizable pit, alternatively at least 2, 3, or 4. In some embodiments, a ″pit″ may be a feature characterized by a width and a depth, where the depth to width ratio is at least 0.25, alternatively at least 0.5. The pit may be a concavity defined by the current collector. The top of the pit may be the top surface of the current collector. In some embodiments, a pit may be at least 2 µm wide. In some embodiments, pits may occupy 2% to 5% of the surface area of the current collector, alternatively 5% to 10%, alternatively, 10% to 20%, alternatively 20% to 30%, alternatively 30% to 40%, alternatively 40% to 50%. In some embodiments, some etched areas or pitted areas may have a fine roughness structure formed from the coalescence of secondary smaller pits or craters. Such secondary pits may have an average width or diameter of less than about 2 µm, alternatively less than about 1 µm. In some embodiments, secondary pits may occupy 5% to 10% of the surface area of the current collector, alternatively 5% to 10%, alternatively, 10% to 20%, alternatively 20% to 30%, alternatively 30% to 40%, alternatively 40% to 50%, alternatively 50% to 60%, alternatively, 60% to 70%, alternatively 70% to 90%.

### Surface Layer

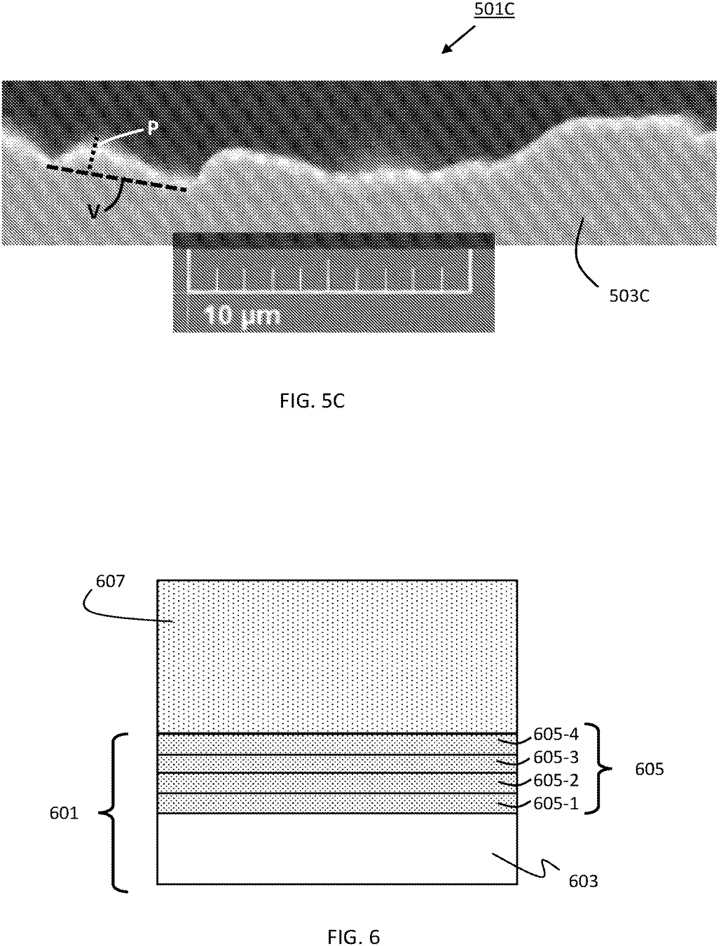

In some embodiments, the surface layer may include zinc, a metal-oxygen compound, or a silicon compound, or a combination thereof. In some embodiments, the surface layer includes at least a metal-oxygen compound in addition to either zinc or a silicon compound, or both zinc and a silicon compound. The surface layer may optionally include additional materials. In some embodiments, the surface layer may include two or more sublayers. Each sublayer of the two or more sublayers may have a composition different from the adjacent sublayer(s). The composition in each sublayer may be homogenous or heterogenous. In some embodiments, at least one sublayer includes zinc, a metal-oxygen compound, or a silicon compound. In some embodiments, at least one sublayer includes a metal-oxygen compound, and at least one other sublayer includes zinc or a silicon compound. A non-limiting example is shown in FIG. 6 illustrating surface layer 605 having up to four surface sublayers. Surface sublayer 605-1 overlays the electrically conductive layer 603. Surface sublayer 605-2 overlays surface sublayer 605-1, surface sublayer 605-3 overlays surface sublayer 605-2, and surface sublayer 605-4 overlays surface sublayer 605-3. Continuous porous lithium storage layer 607 is provided over the uppermost surface sublayer, i.e., the sublayer furthest from the electrically conductive layer 603, which in FIG. 6 may be sublayer 605-4 if all four sublayers are present.

In some embodiments, the surface layer or a sublayer may include zinc (″surface material A″). In some embodiments, the surface layer or a sublayer may include a metal-oxygen compound (″surface material B″). In some embodiments, the surface layer or a sublayer may include a silicon compound including or derived from a siloxane, a silane (i.e., a silane-containing compound), a silazane, or a reaction product thereof (″surface material C″). Herein, a ″silicon compound″ does not include simple elemental silicon such as amorphous silicon. In some embodiments, a sublayer may include a metal oxide or a metal chalcogenide (″surface material D″). These materials are described in more detail below. Using FIG. 6 to help illustrate, Table 1 provides some non-limiting examples of surface layers wherein the surface materials are listed as A, B, C, and/or D, and in which sublayer. In some cases, ″B & C″ refers to a mixture of the two in a single surface sublayer. In embodiments where B or D is provided in sublayer 605-2 over A in sublayer 605-1, the metal of B or D is other than zinc.

TABLE 1

Surface Material

| Surface layer example no. | Sublayer 605-1 | Sublayer 605-2 | Sublayer 605-3 | Sublayer 605-4 |
|---|---|---|---|---|
| 1 | A | B | | |
| 2 | A | D | | |
| 3 | A | B | C | |
| 4 | A | B | C | D |
| 5 | A | B | D | |
| 6 | A | B & C | | |
| 7 | A | B & C | D | |
| 8 | A | D | C | |
| 9 | B | C | | |
| 10 | B | C | D | |
| 11 | B | D | | |
| 12 | B | D | C | |
| 13 | B & C | | | |
| 14 | D | C | | |
| 15 | D | B & C | | |
| 16 | B & C | | | |

### Zinc (Surface Material A)

In some embodiments, the surface layer or sublayer includes metallic zinc or a zinc alloy, which may be deposited, for example, by electrolytic plating, electroless plating, physical vapor deposition, chemical vapor deposition or sputtering. Representative electrolytic plating solutions include those based on zinc pyrophosphate, zinc chloride, zinc cyanide or zinc sulfate plating. For example, a zinc pyrophosphate plating solution may be used having zinc concentration of 5 g/l to 30 g/l, a potassium pyrophosphate concentration of 50 g/l to 500 g/l, and pH 9 to pH 12. Plating may be carried out at a solution temperature of 20° C. to 50° C. by cathodic polarization of the electrically conductive layer under current density of 0.003 A/cm2 to 0.10 A/cm2 for a few seconds to a few minutes. In some embodiments, the zinc plating solution may further include a manganese, stannous or nickel salt to form a zinc-manganese alloy, a zinc-tin alloy, or a zinc-nickel alloy. Herein, zinc alloys include zinc-containing layers where less than 98 atomic % of all metal atoms are zinc. Conversely, non-alloyed zinc includes zinc-containing layers where at least 98 atomic % is zinc. In some embodiments, a zinc-nickel alloy may include 3 - 5 atomic % nickel, alternatively 5 - 10 atomic % nickel, alternatively 10 - 15 atomic % nickel, alternatively 15 - 20 atomic % nickel, alternatively 20 - 30 atomic % nickel, alternatively 30 - 45 atomic % nickel. Numerous other plating compositions and conditions are available and may be used instead.

In some embodiments, the amount of zinc in the surface layer or sublayer may be at least 1 mg/m2, alternatively at least 2 mg/m2, alternatively at least 5 mg/m2. In some embodiments, the amount of zinc is less than 1000 mg/m2. In some embodiments, the amount of zinc may be in a range of 1 - 2 mg/m2, alternatively 2 - 5 mg/m2, alternatively 5 - 10 mg/m2, alternatively 10 - 20 mg/m2, alternatively 20 - 50 mg/m2, alternatively 50 - 75 mg/m2, alternatively 75 - 100 mg/m2, alternatively 100 - 250 mg/m2, alternatively 250 - 500 mg/m2, alternatively 500 - 1000 mg/m2, alternatively 1000 - 2000 mg/m2, alternatively 2000 - 3000 mg/m2, alternatively 3000 - 4000 mg/m2, alternatively 4000 - 5000 mg/m2, or any combination of ranges thereof. In some embodiments, a surface layer or surface sublayer including zinc-nickel alloy may include at least 500 mg/m2 of zinc. In some embodiments, a surface layer or surface sublayer including non-alloy zinc may be less than 500 mg/m2 of zinc. In some embodiments, a surface layer or sublayer having a zinc-containing material may be at least 0.2 nm thick, alternatively at least 0.5 nm thick, alternatively at least 1 nm thick, at least 2 nm thick. In some embodiments a surface layer or sublayer having a zinc-containing material has a thickness in a range of 0.2 - 0.5 nm, alternatively 0.5 - 1.0 nm, alternatively 1.0 - 2.0 nm, alternatively 2.0 - 5.0 nm, alternatively 5.0 - 10 nm, alternatively 10 - 20 nm, alternatively 20 -50 nm, alternatively 50 - 100 nm, alternatively 100 - 200 nm, alternatively 200 - 300 nm, alternatively 300 — 400 nm, alternatively 400 - 500 nm, 500 - 700 nm, or any combination of ranges thereof.

### Metal-Oxygen Compound (Surface Material B)

In some embodiments, the surface layer or surface sublayer includes a metal-oxygen compound that includes a transition metal. Unless otherwise noted, the term ″transition metal″ as used anywhere in the present application includes any element in groups 3 through 12 of the periodic table, including lanthanides and actinides. Metal-oxygen compounds may include transition metal oxides, transition metal hydroxides, transition oxometallates, or a mixture thereof. Note that oxometallates may be considered a subset of metal oxides where the metal oxide is anionic in nature and is associated with a cation, which may optionally be an alkali metal, an alkaline earth metal, or a transition metal (that is the same or different than the transition metal of the oxometallate). In some embodiments, the transition metal of the metal-oxygen compound includes titanium, vanadium, chromium, manganese, iron, cobalt, nickel, molybdenum, tungsten, zirconium, or niobium. In some embodiments, the metal-oxygen compound may include, or be derived from, a transition oxometallate including, but not limited to, a chromate, tungstate, or molybdate. Metal-oxygen compounds may be coated from solution, electrolytically plated, or electrolessly plated (which may include “immersion plating”). In some embodiments, such electrolytic or electroless plating may use a solution including a transition oxometallate. In some cases, the nature of the deposited coating may include a mixture of transition metal oxide, hydroxide and/or oxometallate.

A non-limiting, representative electrolytic chromate solution may have a chromic acid or potassium chromate concentration of 2 g/l to 7 g/l, and pH of 10 to 12. The solution may optionally be warmed to a temperature of 30° C. to 40° C. and a cathodic current density of 0.02 to 8 A/cm2 applied to the electrically conductive layer, typically for a few seconds, to deposit the chromium-containing metal-oxygen compound. In some embodiments, such a surface layer or surface sublayer may be referred to as a chromate-treatment layer. The deposited chromium-containing metal-oxygen compound may include one or more of chromium oxide, chromium hydroxide, or chromate. At least some of the chromium may be present as chromium (III).

In some embodiments, the amount of chromium in the surface layer or sublayer may be at least 0.5 mg/m2, alternatively at least 1 mg/m2, alternatively at least 2 mg/m2. In some embodiments, the amount of chromium is less than 250 mg/m2. In some embodiments, the amount of chromium may be in a range of 0.5 - 1 mg/cm2, alternatively 1 - 2 mg/m2, alternatively 2 - 5 mg/m2, alternatively 5 - 10 mg/m2, alternatively 10 - 20 mg/m2, alternatively 20 - 50 mg/m2, alternatively 50 - 75 mg/m2, alternatively 75 - 100 mg/m2, alternatively 100 -250 mg/m2, or any combination of ranges thereof. In some embodiments, a surface layer or sublayer having a chromium-containing material may be at least 0.2 nm thick, alternatively at least 0.5 nm thick, alternatively at least 1 nm thick, at least 2 nm thick. In some embodiments a surface layer or sublayer having a chromium-containing material has a thickness in a range of 0.2 - 0.5 nm, alternatively 0.5 - 1.0 nm, alternatively 1.0 - 2.0 nm, alternatively 2.0 - 5.0 nm, alternatively 5.0 - 10 nm, alternatively 10 - 20 nm, alternatively 20 - 50 nm, alternatively 50 -100 nm, or any combination of ranges thereof.

### Silicon Compounds (Surface Material C)

In some embodiments, a surface layer or sublayer includes a silicon compound formed by treatment with a silane, a siloxane, or a silazane compound, any of which may be referred to herein as a silicon compound agent. In some embodiments, the silicon compound agent treatment may increase adhesion to an overlying sublayer or to the continuous porous lithium storage layer. In some embodiments, the silicon compound may be a polymer including, but not limited to, a polysiloxane. In some embodiments, a siloxane compound may have a general structure as shown in formula (1)

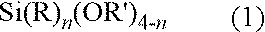

wherein, n = 1, 2, or 3, and R and R′ are independently selected substituted or unsubstituted alkyl, alkenyl, or aryl groups.

The silicon compound of the layer or sublayer may be derived from a silicon compound agent but have a different chemical structure than the agent used to form it. In some embodiments, the silicon compound may react with the underlying surface to form a bond such as a metal-oxygen-silicon bond, and in doing so, the silicon compound may lose one or more functional groups (e.g., an OR′ group from a siloxane). In some embodiments, the silicon compound agent may include groups that polymerize to form a polymer. In some embodiments, the silicon compound agent may form a matrix of Si—O—Si cross links. In some embodiments, the PECVD deposition of a lithium storage material may alter the chemical structure of the silicon compound agent or even form a secondary derivative chemical species. The silicon compound includes silicon. The silicon compound may be the result of a silicon compound agent reacting with 1, 2, 3, or 4 reactants in 1, 2, 3, or 4 different reactions.

A silicon compound agent may be provided in a solution, e.g., at about 0.3 g/l to 15 g/l in water or an organic solvent. Adsorption methods of a silicon compound agent include an immersion method, a showering method and a spraying method and are not especially limited. In some embodiments a silicon compound agent may be provided as a vapor and adsorbed onto an underlying sublayer. In some embodiments, a silicon compound agent may deposited by initiated chemical vapor deposition (iCVD). In some embodiments, a silicon compound agent may include an olefin-functional silane moiety, an epoxy-functional silane moiety, an acryl-functional silane moiety, an amino-functional silane moiety, or a mercapto-functional silane moiety, optionally in combination with siloxane or silazane groups. In some embodiments, the silicon compound agent may be a siloxysilane. In some embodiments, a silicon compound agent may undergo polymerization during deposition or after deposition. Some non-limiting examples of silicon compound agents include hexamethyldisilazane (HMDS), vinyltrimethoxysilane, vinylphenyltrimethoxysilane, 3-methacryloxypropyltrimethoxysilane, 3-glycidoxypropyltrimethoxysilane, 3-glycidoxypropyltriethoxysilane, 4-glycidylbutyltrimethoxysilane, 3-aminopropyltriethoxysilane, N-2-(aminoethyl)-3-aminopropyltrimethoxysilane, N-3-(4-(3-aminopropoxy)butoxy)propyl-3-aminopropyltrimethoxysilane, imidazolesilane, triazinesilane, 3-mercaptopropyltrimethoxysilane, 1,3,5,7-tetravinyl-1,3,5,7-tetramethylcyclotetrasiloxane, 1,3,5-trivinyl-1,3,5-trimethylcyclotrisiloxane, pentavinylpentamethylcyclopentasiloxane, and octavinyl-T8-silesquioxane. In some embodiments, a layer or sublayer including a silicon compound may include silicon, oxygen, and carbon, and may further include nitrogen or sulfur.

In some embodiments, treatment with a silicon compound agent may be followed by a step to drive off solvent or to initiate polymerization or another chemical transformation, wherein the step may involve heating, contact with a reactive reagent, or both. A surface sublayer formed from a silicon compound agent should not be so thick as to create a significant barrier to charge conduction between the current collector and the continuous porous lithium storage layer. In some embodiments, a sublayer formed from a silicon compound agent has a silicon content in a range of 0.1 to 0.2 mg/m², alternatively in a range of 0.1 - 0.25 mg/m², alternatively in a range of 0.25 - 0.5 mg/m², alternatively in a range of 0.5 - 1 mg/m², alternatively 1 - 2 mg/m², alternatively 2 - 5 mg/m², alternatively 5 - 10 mg/m², alternatively 10 - 20 mg/m², alternatively 20 - 50 mg/m², alternatively 50 - 100 mg/m², alternatively 100 - 200 mg/m², alternatively 200 -300 mg/m², or any combination of ranges thereof. In some embodiments, a surface layer or sublayer formed from a silicon compound agent may include up to one monolayer of the silicon compound agent or its reaction product, alternatively up to 2 monolayers; alternatively up to 4 monolayers, alternatively up to 6 monolayers, alternatively up to 8 monolayers, alternatively up to 10 monolayers, alternatively up to 15 monolayers, alternatively up to 20 monolayers, alternatively up to 50 monolayers, alternatively up to 100 monolayers, alternatively up to 200 monolayers. The surface layer or surface sublayer having the silicon compound may be porous. In some embodiments, the silicon compound may break down or partially breaks down during deposition of the lithium storage layer.

### Metal Oxides or Metal Chalcogenides (Surface Material D)

In some embodiments, a surface sublayer may include a metal oxide and such surface sublayers may be referred to as a metal oxide sublayer. In some embodiments, the metal oxide sublayer includes a transition metal oxide. In some embodiments, the metal oxide sublayer includes an oxide of titanium, vanadium, chromium, manganese, iron, cobalt, nickel, copper, zinc, molybdenum, tungsten, silver, zirconium, hafnium, tin, aluminum, indium, or niobium. In some embodiments, the metal oxide sublayer is an electrically conductive doped oxide, including but not limited to, indium-doped tin oxide (ITO) or an aluminum-doped zinc oxide (AZO). In some embodiments, the metal oxide sublayer includes an alkali metal oxide or alkaline earth metal oxide. In some embodiments the metal oxide sublayer includes an oxide of lithium. The metal oxide sublayer may include mixtures of metals. For example, an ″oxide of nickel″ may optionally include other metals in addition to nickel. In some embodiments, the metal oxide sublayer includes an oxide of an alkali metal (e.g., lithium or sodium) or an alkaline earth metal (e.g., magnesium or calcium) along with an oxide of a transition metal (e.g., titanium, nickel, or copper). In some embodiments, the metal oxide sublayer may include a small amount of hydroxide such that the ratio of oxygen atoms in the form of hydroxide relative to oxide is less than 1 to 4, respectively. The metal oxide sublayer may include a stoichiometric oxide, a non-stoichiometric oxide or both. In some embodiments, the metal within the metal oxide sublayer may exist in multiple oxidation states. Ordinarily, oxometallates may be considered a subclass of metal oxides. For the sake of clarity, any reference herein to ″metal oxide″ with respect to its use in a surface sublayer excludes oxometallates.

In some embodiments, the metal oxide sublayer may be at least 1 monolayer in thickness, alternatively at least 2, 3, 5, or 10 monolayers. In some embodiments, the metal oxide sublayer may have an average thickness of at least 0.1 nm, alternatively at least 0.2 nm. In some embodiments, a metal oxide sublayer has an average thickness of less than 5000 nm, alternatively less than 3000 nm. In some embodiments, the metal oxide sublayer has an average thickness in a range of 0.5 - 1 nm, alternatively 1 - 2 nm, alternatively 2 - 5 nm, alternatively 5 to 10 nm, alternatively 10 - 20 nm, alternatively 20 - 50 nm, alternatively 50 - 100 nm, alternatively 100 - 200 nm, alternatively 200 - 500 nm, alternatively 500 - 1000 nm, alternatively 1000 - 1500 nm, alternatively 1500 - 2000 nm, alternatively 2000 - 2500 nm, alternatively 2500 - 3000 nm, alternatively 3000 - 4000 nm, alternatively 4000 - 5000 nm, or any combination of ranges thereof.

In some embodiments, the metal oxide sublayer is formed by atomic layer deposition (ALD), chemical vapor deposition (CVD), thermal vapor deposition, or sputtering.

In some embodiments, a metal oxide sublayer precursor composition may be coated or printed over a current collector having one or more surface sublayers as described above the and then treated to form metal oxide sublayer. Some non-limiting examples of metal oxide precursor compositions include sol-gels (metal alkoxides), metal carbonates, metal acetates (including organic acetates), metal hydroxides and metal oxide dispersions. The metal oxide precursor composition may be thermally treated to form the metal oxide sublayer.

In some embodiments, the metal oxide sublayer precursor composition includes a metal, e.g., metal-containing particles or a sputtered metal layer. The metal may then be oxidized in the presence of oxygen (e.g., thermally), electrolytically oxidized, chemically oxidized in an oxidizing liquid or gaseous medium or the like to form the metal oxide sublayer.

In some embodiments, a sublayer may include a metal chalcogenide such as a metal sulfide or metal selenide. Metal chalcogenides may be deposited by ALD, CVD, thermal vapor deposition, or sputtering. Alternatively, metal chalcogenides may be deposited by a coating method from a solution or a mixture. In some embodiments, a metal chalcogenide sublayer may be formed by chemically reacting a metal with a metal sulfide forming reactant. In some embodiments, the metal chalcogenide sublayer has an average thickness of at least 0.1 nm, alternatively at least 0.2 nm. In some embodiments, a metal chalcogenide sublayer may have an average thickness of less than 5000 nm, alternatively less than 3000 nm. In some embodiments, the metal oxide sublayer has an average thickness in a range of 0.5 - 1 nm, alternatively 1 - 2 nm, alternatively 2 - 5 nm, alternatively 5 to 10 nm, alternatively 10 - 20 nm, alternatively 20 -50 nm, alternatively 50 - 100 nm, alternatively 100 - 200 nm, alternatively 200 - 500 nm, alternatively 500 - 1000 nm, alternatively 1000 - 1500 nm, alternatively 1500 - 2000 nm, alternatively 2000 - 2500 nm, alternatively 2500 - 3000 nm, alternatively 3000 - 4000 nm, alternatively 4000 - 5000 nm, or any combination of ranges thereof.

In some embodiments, the ratio of the average thickness of the surface layer (including all sublayers, if present) to the average thickness of the electrically conducting layer is less than 1, alternatively less than 0.5, alternatively less than 0.2, alternatively less than 0.1, alternatively less than 0.05, alternatively less than 0.02, alternatively less than 0.01, alternatively less than 0.005.

In some embodiments, prior to depositing the continuous porous lithium storage layer, the current collector may be thermally treated (optionally under inert conditions). Such heating may improve the physical properties of the current collector, e.g., by reducing internal stresses, improving adhesion between various layers and sublayers of the current collector, or both. The temperature and time of the aforementioned thermal treatment step depend largely on choice of materials. In some embodiment, the thermal treatment includes heating to a temperature in a range of 100 - 200° C., alternatively 200 - 300° C., alternatively 300 - 400° C., alternatively 400 -500° C., or any combination of ranges thereof. In some embodiments, the thermal treatment step includes exposure to one of the aforementioned temperature ranges for time in a range of 1 - 10 minutes, alternatively 10 - 30 minutes, alternatively 30 - 60 minutes, alternatively 1 - 2 hours, alternatively 2 - 4 hours, alternatively 4 - 8 hours, alternatively 8 - 16 hours, alternatively 16 -24 hours, or any combination of ranges thereof.

### Lithium Storage Layer

In some embodiments, the lithium storage layer may be a continuous porous lithium storage layer that includes a porous material capable of reversibly incorporating lithium. In some embodiments, the continuous porous lithium storage layer includes silicon, germanium, antimony, tin, or a mixture of two or more of these elements. In some embodiments, the continuous porous lithium storage layer is substantially amorphous. In some embodiments, the continuous porous lithium storage layer includes substantially amorphous silicon. Such substantially amorphous storage layers may include a small amount (e.g., less than 20 atomic %) of crystalline material dispersed therein. The continuous porous lithium storage layer may include dopants such as hydrogen, boron, phosphorous, sulfur, fluorine, aluminum, gallium, indium, arsenic, antimony, bismuth, nitrogen, or metallic elements. In some embodiments the continuous porous lithium storage layer may include porous substantially amorphous hydrogenated silicon (a-Si:H), having, e.g., a hydrogen content of from 0.1 to 20 atomic %, or alternatively higher. In some embodiments, the continuous porous lithium storage layer may include methylated amorphous silicon. Note that, unless referring specifically to hydrogen content, any atomic % metric used herein for a lithium storage material or layer refers to atoms other than hydrogen.

In some embodiments, the continuous porous lithium storage layer includes at least 40 atomic % silicon, germanium or a combination thereof, alternatively at least 50 atomic %, alternatively at least 60 atomic %, alternatively at least 70 atomic %, alternatively, at least 80 atomic %, alternatively at least 90 atomic %. In some embodiments, the continuous porous lithium storage layer includes at least 40 atomic % silicon, alternatively at least 50 atomic %, alternatively at least 60 atomic %, alternatively at least 70 atomic %, alternatively, at least 80 atomic %, alternatively at least 90 atomic %, alternatively at least 95 atomic %, alternatively at least 97 atomic %. Note that in the case of prelithiated anodes as discussed below, the lithium content is excluded from this atomic % characterization.

In some embodiments, the continuous porous lithium storage layer includes less than 10 atomic % carbon, alternatively less than 5 atomic %, alternatively less than 2 atomic %, alternatively less than 1 atomic %, alternatively less than 0.5 atomic %. In some embodiments, the continuous porous lithium storage layer is substantially free (i.e., the continuous porous lithium storage layer includes less than 1% by weight, alternatively less than 0.5% by weight) of carbon-based binders, graphitic carbon, graphene, graphene oxide, reduced graphene oxide, carbon black and conductive carbon. A few non-limiting examples of carbon-based binders may include organic polymers such as those based on styrene butadiene rubber, polyvinylidene fluoride, polytetrafluoroethylene, polyacrylic acid, carboxymethyl cellulose, or polyacrylonitrile.

The continuous porous lithium storage layer may include voids or interstices (pores), which may be random or non-uniform with respect to size, shape, and distribution. Such porosity does not result in, or a result from, the formation of any recognizable lithium storage nanostructures such as nanowires, nanopillars, nanotubes, ordered nanochannels or the like. In some embodiments, the pores may be polydisperse. In some embodiments, the continuous porous lithium storage layer may be characterized as nanoporous. In some embodiments the continuous porous lithium storage layer has an average density in a range of 1.0 - 1.1 g/cm³, alternatively 1.1 - 1.2 g/cm³, alternatively 1.2 - 1.3 g/cm³, alternatively 1.3 - 1.4 g/cm³, alternatively 1.4 - 1.5 g/cm³, alternatively 1.5 - 1.6 g/cm³, alternatively 1.6 - 1.7 g/cm³, alternatively 1.7 - 1.8 g/cm³, alternatively 1.8 - 1.9 g/cm³, alternatively 1.9 - 2.0 g/cm³, alternatively 2.0 - 2.1 g/cm³, alternatively 2.1 - 2.2 g/cm³, alternatively 2.2 - 2.25 g/cm³, alternatively 2.25 - 2.29 g/cm³, or any combination of ranges thereof, and includes at least 70 atomic % silicon, 80 atomic % silicon, alternatively at least 85 atomic % silicon, alternatively at least 90 atomic % silicon, alternatively at least 95 atomic % silicon. Note that a density of less than 2.3 g/cm³ is evidence of the porous nature of a-Si containing lithium storage layers.

In some embodiments, the majority of active material (e.g., silicon, germanium or alloys thereof) of the continuous porous lithium storage layer has substantial lateral connectivity across portions of the current collector creating, such connectivity extending around random pores and interstices. Referring again to FIG. 1, in some embodiments, “substantial lateral connectivity” means that active material at one point X in the continuous porous lithium storage layer 107 may be connected to active material at a second point X′ in the layer at a straight-line lateral distance LD that is at least as great as the average thickness T of the continuous porous lithium storage layer, alternatively, a lateral distance at least 2 times as great as the thickness, alternatively, a lateral distance at least 3 times as great as the thickness. Not shown, the total path distance of material connectivity, including circumventing pores and following the topography of the current collector, may be longer than LD. In some embodiments, the continuous porous lithium storage layer may be described as a matrix of interconnected silicon, germanium or alloys thereof, with random pores and interstices embedded therein. In some embodiments, the continuous porous lithium storage layer may have a sponge-like form. It should be noted that the continuous porous lithium storage layer does not necessarily extend across the entire anode without any lateral breaks and may include random discontinuities or cracks and still be considered continuous. In some embodiments, such discontinuities may occur more frequently on rough current collector surfaces. In some embodiments, the continuous porous lithium storage layer may include adjacent columns of silicon and/or silicon nanoparticle aggregates.

In some embodiments, the continuous porous lithium storage layer includes a substoichiometric oxide of silicon (SiOₓ), germanium (GeOₓ) or tin (SnOₓ) wherein the ratio of oxygen atoms to silicon, germanium or tin atoms is less than 2:1, i.e., x < 2, alternatively less than 1:1, i.e., x < 1. In some embodiments, x is in a range of 0.02 to 0.95, alternatively 0.02 to 0.10, alternatively 0.10 to 0.50, or alternatively 0.50 to 0.95, alternatively 0.95 to 1.25, alternatively 1.25 to 1.50, or any combination of ranges thereof.

In some embodiments, the continuous porous lithium storage layer includes a substoichiometric nitride of silicon (SiN_{y}), germanium (GeN_{y}) or tin (SnN_{y}) wherein the ratio of nitrogen atoms to silicon, germanium or tin atoms is less than 1.25:1, i.e., y < 1.25. In some embodiments, y is in a range of 0.02 to 0.95, alternatively 0.02 to 0.10, alternatively 0.10 to 0.50, or alternatively 0.50 to 0.95, alternatively 0.95 to 1.20, or any combination of ranges thereof. Lithium storage layer having a substoichiometric nitride of silicon may also be referred to as nitrogen-doped silicon or a silicon-nitrogen alloy.

In some embodiments, the continuous porous lithium storage layer includes a substoichiometric oxynitride of silicon (SiOₓN_{y}), germanium (GeOₓN_{y}), or tin (SnOₓN_{y}) wherein the ratio of total oxygen and nitrogen atoms to silicon, germanium or tin atoms is less than 1:1, i.e., (x + y) < 1. In some embodiments, (x + y) is in a range of 0.02 to 0.95, alternatively 0.02 to 0.10, alternatively 0.10 to 0.50, or alternatively 0.50 to 0.95, or any combination of ranges thereof.

In some embodiments, the above sub-stoichiometric oxides, nitrides or oxynitrides are provided by a CVD process, including but not limited to, a PECVD process. The oxygen and nitrogen may be provided uniformly within the continuous porous lithium storage layer, or alternatively the oxygen or nitrogen content may be varied as a function of storage layer thickness.

### CVD

CVD generally involves flowing a precursor gas, a gasified liquid in terms of direct liquid injection CVD or gases and liquids into a chamber containing one or more objects, typically heated, to be coated. Chemical reactions may occur on and near the hot surfaces, resulting in the deposition of a thin film on the surface. This is accompanied by the production of chemical by-products that are exhausted out of the chamber along with unreacted precursor gases. As would be expected with the large variety of materials deposited and the wide range of applications, there are many variants of CVD that may be used to form the lithium storage layer, the surface layer or sublayer, a supplemental layer (see below) or other layers. It may be done in hot-wall reactors or cold-wall reactors, at sub-torr total pressures to above-atmospheric pressures, with and without carrier gases, and at temperatures typically ranging from 100 -1600° C. in some embodiments. There are also a variety of enhanced CVD processes, which involve the use of plasmas, ions, photons, lasers, hot filaments, or combustion reactions to increase deposition rates and/or lower deposition temperatures. Various process conditions may be used to control the deposition, including but not limited to, temperature, precursor material, gas flow rate, pressure, substrate voltage bias (if applicable), and plasma energy (if applicable).

As mentioned, the continuous porous lithium storage layer, e.g., a layer of silicon or germanium or both, may be provided by plasma-enhanced chemical vapor deposition (PECVD). Relative to conventional CVD, deposition by PECVD can often be done at lower temperatures and higher rates, which can be advantageous for higher manufacturing throughput. In some embodiments, the PECVD is used to deposit a substantially amorphous silicon layer (optionally doped) over the surface layer. In some embodiments, PECVD is used to deposit a substantially amorphous continuous porous silicon layer over the surface layer.

In PECVD processes, according to various implementations, a plasma may be generated in a chamber in which the substrate is disposed or upstream of the chamber and fed into the chamber. Various types of plasmas may be used including, but not limited to, capacitively-coupled plasmas, inductively-coupled plasmas, and conductive coupled plasmas. Any appropriate plasma source may be used, including DC, AC, RF, VHF, combinatorial PECVD and microwave sources may be used. In some embodiments, magnetron assisted RF PECVD may be used

PECVD process conditions (temperatures, pressures, precursor gases, carrier gasses, dopant gases, flow rates, energies, and the like) can vary according to the particular process and tool used, as is well known in the art.

In some implementations, the PECVD process is an expanding thermal plasma chemical vapor deposition (ETP-PECVD) process. In such a process, a plasma generating gas is passed through a direct current arc plasma generator to form a plasma, with a web or other substrate including the current collector optionally in an adjoining vacuum chamber. A silicon source gas is injected into the plasma, with radicals generated. The plasma is expanded via a diverging nozzle and injected into the vacuum chamber and toward the substrate. An example of a plasma generating gas is argon (Ar). In some embodiments, the ionized argon species in the plasma collide with silicon source molecules to form radical species of the silicon source, resulting in deposition onto the current collector. Example ranges for voltages and currents for the DC plasma source are 60 to 80 volts and 40 to 70 amperes, respectively.

Any appropriate silicon source may be used to deposit silicon. In some embodiments, the silicon source may be a silane-containing gas including, but not limited to, silane (SiB₄), dichlorosilane (H₂SiCl₂), monochlorosilane (H₃SiCl), trichlorosilane (HSiCl₃), silicon tetrachloride (SiCl₄), and diethylsilane. Depending on the gas(es) used, the silicon layer may be formed by decomposition or reaction with another compound, such as by hydrogen reduction. In some embodiments, the gases may include a silicon source such as silane, a noble gas such as helium, argon, neon, or xenon, optionally one or more dopant gases, and substantially no hydrogen. In some embodiments, the gases may include argon, silane, and hydrogen, and optionally some dopant gases. In some embodiments the gas flow ratio of argon relative to the combined gas flows for silane and hydrogen is at least 3.0, alternatively at least 4.0. In some embodiments, the gas flow ratio of argon relative to the combined gas flows for silane and hydrogen is in a range of 3 - 5, alternatively 5 - 10, alternatively 10 - 15, alternatively 15 - 20, or any combination of ranges thereof. In some embodiments, the gas flow ratio of hydrogen gas to silane is in a range of 0 - 0.1, alternatively 0.1 - 0.2, alternatively 0.2 - 0.5, alternatively 0.5 - 1, alternatively 1 - 2, alternatively 2 - 5, or any combination of ranges thereof. In some embodiments, higher porosity silicon may be formed and/or the rate of silicon deposition may be increased when the gas flow ratio of silane relative to the combined gas flows of silane and hydrogen increases. In some embodiments a dopant gas is borane or phosphine, which may be optionally mixed with a carrier gas. In some embodiments, the gas flow ratio of dopant gas (e.g., borane or phosphine) to silicon source gas (e.g., silane) is in a range of 0.0001 - 0.0002, alternatively 0.0002 - 0.0005, alternatively 0.0005 - 0.001, alternatively 0.001 - 0.002, alternatively 0.002 - 0.005, alternatively 0.005 - 0.01, alternatively 0.01 - 0.02, alternatively 0.02 - 0.05, alternatively 0.05 - 0.10, or any combination of ranges thereof. Such gas flow ratios described above may refer to the relative gas flow, e.g., in standard cubic centimeters per minute (SCCM). In some embodiments, the PECVD deposition conditions and gases may be changed over the course of the deposition.

In some embodiments, the temperature at the current collector during at least a portion of the time of PECVD deposition is in a range of 20° C. to 50° C., 50° C. to 100° C., alternatively 100° C. to 200° C., alternatively 200° C. to 300° C., alternatively 300° C. to 400° C., alternatively 400° C. to 500° C., alternatively 500° C. to 600° C., or any combination of ranges thereof. In some embodiments, the temperature may vary during the time of PECVD deposition. For example, the temperature during early times of the PECVD may be higher than at later times. Alternatively, the temperature during later times of the PECVD may be higher than at earlier times.

The thickness or mass per unit area of the continuous porous lithium storage layer depends on the storage material, desired charge capacity and other operational and lifetime considerations. Increasing the thickness typically provides more capacity. If the continuous porous lithium storage layer becomes too thick, electrical resistance may increase and the stability may decrease. In some embodiments, the anode may be characterized as having an active silicon areal density of at least 1.0 mg/cm², alternatively at least 1.5 mg/cm², alternatively at least 3 mg/cm², alternatively at least 5 mg/cm². In some embodiments, the lithium storage structure may be characterized as having an active silicon areal density in a range of 1.5 - 2 mg/cm², alternatively in a range of 2 - 3 mg/cm², alternatively in a range of 3 - 5 mg/cm², alternatively in a range of 5 - 10 mg/cm², alternatively in a range of 10 - 15 mg/cm², alternatively in a range of 15 on 20 mg/cm², or any combination of contiguous ranges thereof. ″Active silicon″ refers to the silicon in electrical communication with the current collector that is available for reversible lithium storage at the beginning of cell cycling, e.g., after anode ″electrochemical formation″ discussed later. ″Areal density″ refers to the surface area of the electrically conductive layer over which active silicon is provided. In some embodiments, not all of the silicon content is active silicon, i.e., some may be tied up in the form of non-active silicides or may be electrically isolated from the current collector.

In some embodiments the continuous porous lithium storage has an average thickness of at least 1 µm, alternatively at least 2.5 µm, alternatively at least 6.5 µm. In some embodiments, the continuous porous lithium storage layer has an average thickness in a range of about 0.5 µm to about 50 µm. In some embodiments, the continuous porous lithium storage layer comprises at least 80 atomic % amorphous silicon and/or has a thickness in a range of 1 - 1.5 µm, alternatively 1.5 - 2.0 µm, alternatively 2.0 - 2.5 µm, alternatively 2.5 - 3.0 µm, alternatively 3.0 - 3.5 µm, alternatively 3.5 - 4.0 µm, alternatively 4.0 - 4.5 µm, alternatively 4.5 - 5.0 µm, alternatively 5.0 - 5.5 µm, alternatively 5.5 - 6.0 µm, alternatively 6.0 - 6.5 µm, alternatively 6.5 - 7.0 µm, alternatively 7.0 - 8.0 µm, alternatively 8.0 - 9.0 µm, alternatively 9.0 - 10 µm, alternatively 10 - 15 µm, alternatively 15 - 20 µm, alternatively 20 - 25 µm, alternatively 25 - 30 µm, alternatively 30 - 40 µm, alternatively 40 - 50 µm, or any combination of ranges thereof.

### Other Anode Features

The anode may optionally include various additional layers and features. The current collector may include one or more features to ensure that a reliable electrical connection can be made in the energy storage device. In some embodiments, a supplemental layer is provided over the patterned lithium storage structure. In some embodiments, the supplemental layer is a protection layer to enhance lifetime or physical durability. The supplemental layer may be an oxide formed from the lithium storage material itself, e.g., silicon dioxide in the case of silicon, or some other suitable material. A supplemental layer may be deposited, for example, by ALD, CVD, PECVD, evaporation, sputtering, solution coating, ink jet or any method that is compatible with the anode. In some embodiments, the top surface of the supplemental layer may correspond to a top surface of the anode.

A supplemental layer should be reasonably conductive to lithium ions and permit lithium ions to move into and out of the patterned lithium storage structure during charging and discharging. In some embodiments, the lithium ion conductivity of a supplemental layer is at least 10⁻⁹ S/cm, alternatively at least 10⁻⁸ S/cm, alternatively at least 10⁻⁷ S/cm, alternatively at least 10⁻⁶ S/cm. In some embodiments, the supplemental layer acts as a solid-state electrolyte.

Some non-limiting examples of materials used in a supplemental layer include metal oxides, nitrides, or oxynitrides, e.g., those containing aluminum, titanium, vanadium, zirconium, hafnium, or tin, or mixtures thereof. The metal oxide, metal nitride or metal oxynitride may include other components such as phosphorous or silicon. The supplemental layer may include a lithium-containing material such as lithium phosphorous oxynitride (LIPON), lithium phosphate, lithium aluminum oxide, (Li,La)ₓTi_{y}O_{z}, or LiₓSi_{y}A1₂O₃. In some embodiments, the supplemental layer includes a metal oxide, metal nitride, or metal oxynitride, and has an average thickness of less than about 100 nm, for example, in a range of about 0.1 to about 10 nm, or alternatively in a range of about 0.2 nm to about 5 nm. LIPON or other solid-state electrolyte materials having superior lithium transport properties may have a thickness of more than 100 nm, but may alternatively, be in a range of about 1 to about 50 nm.

In some embodiments, the continuous porous lithium storage layer may be at least partially prelithiated prior to a first electrochemical cycle after battery assembly, or alternatively prior to battery assembly. That is, some lithium may be incorporated into the continuous porous lithium storage layer to form a lithiated storage layer even prior to a first battery cycle. In some embodiments, the lithiated storage layer may break into smaller structures, including but not limited to platelets, that remain electrochemically active and continue to reversibly store lithium. Note that ″lithiated storage layer″ simply means that at least some of the potential storage capacity of the lithium storage layer is filled, but not necessarily all. In some embodiments, the lithiated storage layer may include lithium in a range of 1% to 5% of the theoretical lithium storage capacity of the continuous porous lithium storage layer, alternatively 5% to 10%, alternatively 10% to 15%, alternatively 15% to 20%, alternatively, 20% to 30%, alternatively 30% to 40%, alternatively 40% to 50%, alternatively 50% to 60%, alternatively 60% to 70%, alternatively 70% to 80%, alternatively 80% to 90%, alternatively 90% to 100%, or any combination of ranges thereof. In some embodiments, a surface layer may capture some of the lithium, and one may need to account for such capture to achieve the desired lithium range in the lithiated storage layer.

In some embodiments prelithiation may include depositing lithium metal over the continuous porous lithium storage layer, alternatively between one or more lithium storage sublayers, or both, e.g., by evaporation, e-beam or sputtering. Alternatively, prelithiation may include contacting the anode with a reductive lithium organic compound, e.g., lithium naphthalene, n-butyllithium or the like. In some embodiments, prelithiation may include incorporating lithium by electrochemical reduction of lithium ion in prelithiation solution. In some embodiments, prelithiation may include a thermal treatment to aid the diffusion of lithium into the lithium storage layer.

In some embodiments the anode may be thermally treated prior to battery assembly. In some embodiments, thermally treating the anode may improve adhesion of the various layers or electrical conductivity, e.g., by inducing migration of metal from the current collector or atoms from the optional supplemental layer into the continuous porous lithium storage layer. In some embodiments, the continuous porous lithium storage layer includes at least 80 atomic % amorphous silicon and at least 0.05 atomic % copper, alternatively at least 0.1 atomic % copper, alternatively at least 0.2 atomic % copper, alternatively at least 0.5 atomic % copper, alternatively at least 1 atomic % copper. In some embodiments, the continuous porous lithium storage layer may include at least 80 atomic % amorphous silicon and also include copper in an atomic % range of 0.05 - 0.1%, alternatively 0.1 - 0.2%, alternatively 0.2 - 0.5%, alternatively 0.5 - 1%, alternatively 1 - 2 %, alternatively 2 - 3%, alternatively 3 - 5%, alternatively 5 - 7%, or any contiguous combination of ranges thereof. In some embodiments, the aforementioned ranges of atomic % copper may correspond to a cross-sectional area of the continuous porous lithium storage layer of at least 1 µm², which may be measured, e.g., by energy dispersive x-ray spectroscopy (EDS). In some embodiments, there is a gradient where the concentration of copper in portions of the continuous porous lithium storage layer near the current collector is higher than portions further from the current collector. In some embodiments, instead of copper or in addition to copper, the continuous porous lithium storage layer may include another transition metal such as zinc, chromium or titanium, e.g., when the surface layer includes a metal oxide layer of TiO₂. The atomic % of such transition metals (Zn, Cr, or Ti) may be present in the continuous porous lithium storage layer in any of the atomic % ranges mentioned above with respect to copper. In some embodiments, the continuous porous lithium storage layer may include more copper than other transition metals. Special thermal treatments are not always necessary to achieve migration of transition metals into the lithium storage layer.

In some embodiments, thermally treating the anode may be done in a controlled environment having a low oxygen and water (e.g., less than 10 ppm or partial pressure of less than 0.1 Torr, alternatively less than 0.01 Torr content to prevent degradation). In some embodiments, anode thermal treatment may be carried out using an oven, infrared heating elements, contact with a hot plate or exposure to a flash lamp. The anode thermal treatment temperature and time depend on the materials of the anode. In some embodiments, anode thermal treatment includes heating the anode to a temperature of at least 50° C., optionally in a range of 50° C. to 950° C., alternatively 100° C. to 250° C., alternatively 250° C. to 350° C., alternatively 350° C. to 450° C., alternatively 450° C. to 550° C., alternatively 550° C. to 650° C., alternatively 650° C. to 750° C., alternatively 750° C. to 850° C., alternatively 850° C. to 950° C., or a combination of these ranges. In some embodiments, the thermal treatment may be applied for a time period of 0.1 to 120 minutes.

In some embodiments one or more processing steps described above may be performed using roll-to-roll methods wherein the electrically conductive layer or current collector is in the form of a rolled film, e.g, a roll of metal foil, mesh or fabric.

### Battery Features

The preceding description relates primarily to the anode / negative electrode of a lithium-ion battery (LIB). The LIB typically includes a cathode / positive electrode, an electrolyte and a separator (if not using a solid-state electrolyte). As is well known, batteries can be formed into multilayer stacks of anodes and cathodes with an intervening separator. Alternatively, anode/cathode stacks can be formed into a so-called jelly-roll. Such structures are provided into an appropriate housing having desired electrical contacts.

### Cathode

Positive electrode (cathode) materials include, but are not limited to, lithium metal oxides or compounds (e.g., LiCoO₂, LiFePO₄, LiMnO₂, LiNiO₂, LiMn₂O₄, LiCoPO₄, LiNiₓCo_{y}Mn_{z}O₂, LiNixC_{OY}AlzO₂, LiFe₂(SO₄)₃, or Li₂FeSiO₄), carbon fluoride, metal fluorides such as iron fluoride (FeF₃), metal oxide, sulfur, selenium and combinations thereof. Cathode active materials may operate, e.g., by intercalation, conversion, or a combination. Cathode active materials are typically provided on, or in electrical communication with, an electrically conductive cathode current collector.

### Current Separator

The current separator allows ions to flow between the anode and cathode but prevents direct electrical contact. Such separators are typically porous sheets. Non-aqueous lithium-ion separators are single layer or multilayer polymer sheets, typically made of polyolefins, especially for small batteries. Most commonly, these are based on polyethylene or polypropylene, but polyethylene terephthalate (PET) and polyvinylidene fluoride (PVDF) can also be used. For example, a separator can have >30% porosity, low ionic resistivity, a thickness of ~ 10 to 50 µm and high bulk puncture strengths. Separators may alternatively include glass materials, ceramic materials, a ceramic material embedded in a polymer, a polymer coated with a ceramic, or some other composite or multilayer structure, e.g., to provide higher mechanical and thermal stability.

### Electrolyte

The electrolyte in lithium ion cells may be a liquid, a solid, or a gel. A typical liquid electrolyte comprises one or more solvents and one or more salts, at least one of which includes lithium. During the first few charge cycles (sometimes referred to as formation cycles), the organic solvent and/or the electrolyte may partially decompose on the negative electrode surface to form an SEI (Solid-Electrolyte-Interphase) layer. The SEI is generally electrically insulating but ionically conductive, thereby allowing lithium ions to pass through. The SEI may lessen decomposition of the electrolyte in the later charging cycles.

Some non-limiting examples of non-aqueous solvents suitable for some lithium ion cells include the following: cyclic carbonates (e.g., ethylene carbonate (EC), fluoroethylene carbonate (FEC), propylene carbonate (PC), butylene carbonate (BC) and vinylethylene carbonate (VEC)), vinylene carbonate (VC), lactones (e.g., gamma-butyrolactone (GBL), gamma-valerolactone (GVL) and alpha-angelica lactone (AGL)), linear carbonates (e.g., dimethyl carbonate (DMC), methyl ethyl carbonate (MEC, also commonly abbreviated EMC), diethyl carbonate (DEC), methyl propyl carbonate (MPC), dipropyl carbonate (DPC), methyl butyl carbonate (NBC) and dibutyl carbonate (DBC)), ethers (e.g., tetrahydrofuran (THF), 2-methyltetrahydrofuran, 1,4-dioxane, 1,2-dimethoxyethane (DME), 1,2-diethoxyethane and 1,2-dibutoxyethane), nitriles (e.g., acetonitrile and adiponitrile) linear esters (e.g., methyl propionate, methyl pivalate, butyl pivalate and octyl pivalate), amides (e.g., dimethyl formamide), organic phosphates (e.g., trimethyl phosphate and trioctyl phosphate), organic compounds containing an S=O group (e.g., dimethyl sulfone and divinyl sulfone), and combinations thereof.

Non-aqueous liquid solvents can be employed in combination. Examples of these combinations include combinations of cyclic carbonate-linear carbonate, cyclic carbonate-lactone, cyclic carbonate-lactone-linear carbonate, cyclic carbonate-linear carbonate-lactone, cyclic carbonate-linear carbonate-ether, and cyclic carbonate-linear carbonate-linear ester. In some embodiments, a cyclic carbonate may be combined with a linear ester. Moreover, a cyclic carbonate may be combined with a lactone and a linear ester. In some embodiments, the weight ratio, or alternatively the volume ratio, of a cyclic carbonate to a linear ester is in a range of 1:9 to 10:1, alternatively 2:8 to 7:3.

A salt for liquid electrolytes may include one or more of the following non-limiting examples: LiPF₆, LiBF₄, LiCIO₄ LiAsF₆, LiN(CF₃SO₂)₂, LiN(C₂F₃SO₂)₂, LiCF₃SO₃, LiC(CF₃SO₂)₃, LiPF₄(CF₃)₂, LiPF₃(C₂F₅)₃, LiPF₃(CF₃)₃, LiPF₃ (iso-C₃F₇)₃, LiPF₅(iso-C₃F₇), lithium salts having cyclic alkyl groups (e.g., (CF₂)₂(SO₂)₂ₓLi and (CF₂)₃(SO₂)₂ₓLi), LiFSI (lithium bis(fluorosulfonyl)imide), LiTDI (lithium 4,5-dicyano-2-(trifluoromethyl)imidazole), and combinations thereof.

In some embodiments, the total concentration of a lithium salt in a liquid non-aqueous solvent (or combination of solvents) is at least 0.3 M, alternatively at least 0.7 M. The upper concentration limit may be driven by a solubility limit and operational temperature range. In some embodiments, the concentration of salt is no greater than about 2.5 M, alternatively no more than about 1.5 M. In some embodiments, the electrolyte may include a saturated solution of a lithium salt and excess solid lithium salt.

In some embodiments, the battery electrolyte includes a non-aqueous ionic liquid and a lithium salt. Additives may be included in the electrolyte to serve various functions such as to stabilize the battery. For example, additives such as polymerizable compounds having an unsaturated double bond may be added to stabilize or modify the SEI. Certain amines or borate compounds may act as cathode protection agents. Lewis acids can be added to stabilize fluorine-containing anion such as PF₆. Safety protection agents include those to protect overcharge, e.g., anisoles, or act as fire retardants, e.g., alkyl phosphates.

A solid electrolyte may be used without the separator because it serves as the separator itself. It is electrically insulating, ionically conductive, and electrochemically stable. In the solid electrolyte configuration, a lithium containing salt, which could be the same as for the liquid electrolyte cells described above, is employed but rather than being dissolved in an organic solvent, it is held in a solid polymer composite. Examples of solid polymer electrolytes may be ionically conductive polymers prepared from monomers containing atoms having lone pairs of electrons available for the lithium ions of electrolyte salts to attach to and move between during conduction, such as polyvinylidene fluoride (PVDF) or chloride or copolymer of their derivatives, poly(chlorotrifluoroethylene), poly(ethylene-chlorotrifluoro-ethylene), or poly(fluorinated ethylene-propylene), polyethylene oxide (PEO) and oxymethylene linked PEO, PEO-PPO-PEO crosslinked with trifunctional urethane, poly(bis(methoxy-ethoxy-ethoxide))-phosphazene (MEEP), triol-type PEO crosslinked with difunctional urethane, poly((oligo)oxyethylene)methacrylate-co-alkali metal methacrylate, polyacrylonitrile (PAN), polymethylmethacrylate (PMMA), polymethylacrylonitrile (PMAN), polysiloxanes and their copolymers and derivatives, acrylate-based polymer, other similar solvent-free polymers, combinations of the foregoing polymers either condensed or cross-linked to form a different polymer, and physical mixtures of any of the foregoing polymers. Other less conductive polymers that may be used in combination with the above polymers to improve the strength of thin laminates include polyester (PET), polypropylene (PP), polyethylene naphthalate (PEN), polyvinylidene fluoride (PVDF), polycarbonate (PC), polyphenylene sulfide (PPS), and polytetrafluoroethylene (PTFE). Such solid polymer electrolytes may further include a small amount of an organic solvent such as those listed above. The polymer electrolyte may be an ionic liquid polymer Such polymer-based electrolytes can be coated using any number of conventional methods such as curtain coating, slot coating, spin coating, inkjet coating, spray coating or other suitable method.

In some embodiments, the original, non-cycled anode may undergo structural or chemical changes during electrochemical charging/discharging, for example, from normal battery usage or from an earlier “electrochemical formation step”. As is known in the art, an electrochemical formation step is commonly used to form an initial SEI layer and involves relatively gentle conditions of low current and limited voltages. The modified anode prepared in part from such electrochemical charging/discharging cycles may still have excellent performance properties, despite such structural and/or chemical changes relative to the original, non-cycled anode. In some embodiments, the lithium storage layer of the cycled anode may no longer appear as a continuous layer, and instead, appear as separated pillars or islands, generally with a height-to-width aspect ratio of less than 2. While not being bound by theory, in the case of amorphous silicon, it may be that small amounts delaminate upon cycling at high stress areas. Alternatively, or in addition, it may be that structural changes upon lithiation and delithiation are non-symmetrical resulting in such islands or pillars.

In some embodiments, electrochemical cycling conditions may be set to utilize only a portion of the theoretical charge/discharge capacity of silicon (3600 mAh/g). In some embodiments, electrochemical charging/discharging cycles may be set to utilize 400 - 600 mAh/g, alternatively 600 - 800 mAh/g, alternatively 800 - 1000 mAh/g, alternatively 1000 -1200 mAh/g, alternatively 1200 - 1400 mAh/g, alternatively 1400 - 1600 mAh/g, alternatively 1600 - 1800 mAh/g, alternatively 1800 - 2000 mAh/g, alternatively 2000 - 2200 mAh/g, alternatively 2200 - 2400 mAh/g, alternatively 2400 - 2600 mAh/g, alternatively 2600 - 2800 mAh/g, alternatively 2800 - 3000 mAh/g, alternatively 3000 - 3200 mAh/g, alternatively 3200 -3400 mAh/g, or any combination of ranges thereof.

### EXAMPLES

### Test Set A

### Comparative Anode C-1A

Current collector sample CC-1A was a 26 µm thick copper foil having surface roughness of Ra = 0.164 µm and R_{z} = 1.54 µm. CC-1 did not have a surface layer of the present disclosure An attempt was made to deposit silicon onto one side of CC-1 using an Oxford Plasmalabs System 100 PECVD tool at about 300° C. for 30 minutes at an RF power of about 225 W. The deposition gas was a mixture of silane and argon in gas flow ratio of about 1 to 12, respectively. No hydrogen gas was used. The silicon did not adhere sufficiently for electrochemical testing and no further characterization was made.

### Example Anode E-1A

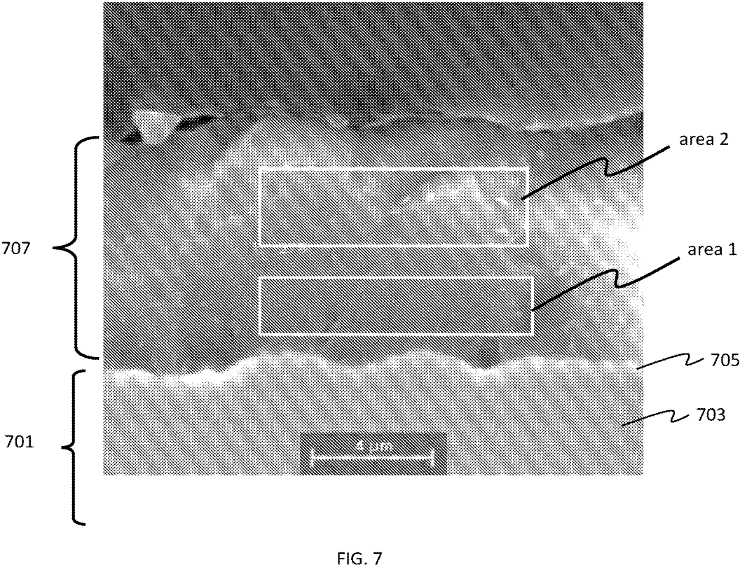

Current collector sample CC-2A was a 10 µm thick commercially available copper foil having a surface roughness of Rₐ = 0.325 µm and R_{z} = 2.85 µm. Based on product literature and analytical data, CC-2A is believed to include a surface layer of the present disclosure having a first surface sublayer of zinc, a second surface sublayer of a metal-oxygen compound including chromium, and a third surface sublayer of silicon compound. An adherent amorphous silicon film (continuous porous lithium storage layer) about 9 µm thick was deposited having a density of about 1.9 mg/cm³ using the same method as described above for Comparative Anode C-1A, but with a deposition time of 50 minutes. An SEM cross section is shown in FIG. 7 showing the continuous porous lithium storage layer 707 (amorphous Si) provided over the current collector 701. The surface roughness of current collector 701 (only a portion is shown) is due mainly by the electrically conductive layer 703 (i.e., the copper foil). The surface layer 705 is difficult to resolve in SEM but is generally conformally deposited over the copper and may have a thickness of less than about 200 nm. Two areas of the continuous porous lithium storage layer were analyzed by energy dispersive x-ray spectroscopy (EDS). Area 1, closest to the current collector was found to have about 5 atomic % copper and 95 atomic % silicon. Area 2, further from the current collector, was found to have about 1 atomic % copper and 99 atomic % silicon. As mentioned, in some embodiments, the migration of metals from the current collector may improve electrical conductivity within the continuous porous lithium storage layer or other physical properties of the anode. The EDS of Anode E-1A suggests some migration of copper from the current collector to the continuous porous lithium storage layer, which may improve the electrical conductivity within the continuous porous lithium storage layer.

### Example Anode E-2A

Current collector sample CC-3A was an 18 µm thick commercially available copper foil having a surface roughness of Rₐ = 0.285 µm and R_{z} = 2.79 µm. Based on product literature and analytical data, CC-3A is believed to include a surface layer of the present disclosure having a first surface sublayer of zinc, a second surface sublayer of a metal-oxygen compound including chromium, and a third surface sublayer of silicon compound. An adherent boron-doped amorphous silicon film about 12 µm thick was deposited having a density of about 1.7 g/cm³ using a method similar to that described above for Comparative Anode 1, except that silane-to-argon gas flow ratio was about 1 to 11, respectively, a boron dopant gas was added, and the deposition time was 46 minutes.

### Example Anode E-3A

Current collector CC-4A was the same as CC-3A, but with 50 nm of TiO₂ deposited by ALD as the uppermost surface sublayer. The surface roughness of CC-4A was also about the same as with CC-3A. An adherent boron-doped amorphous silicon film about 14 µm thick having a density of about 1.7 g/cm³ was deposited using the same conditions as for Anode E-2, but for 50 minutes.

### Electrochemical Testing - Half Cells

Half cells were constructed using a 0.80 cm diameter punch of each anode. Lithium metal served as the counter electrode which was separated from the test anode using Celgard™ separators. The electrolyte solution included: a) 88 wt.% of 1.0 M LiPF₆ in 3:7 EC:EMC (weight ratio); b) 10 wt.% FEC; and 2 wt.% VC. Anodes first underwent an electrochemical formation step. As is known in the art, the electrochemical formation step is used to form an initial SEI layer. Relatively gentle conditions of low current and/or limited voltages may be used to ensure that the anode is not overly stressed. In the present examples, electrochemical formation included several cycles over a wide voltage range (0.01 or 0.06 to 1.2V) at C-rates ranging from C/20 to C/10. The total active silicon (mg/cm²) available for reversible lithiation and total charge capacity (mAh/cm²) were determined from the electrochemical formation step data. While silicon has a theoretical charge capacity of about 3600 mAh/g when used in lithium-ion batteries, it has been found that cycle life significantly improves if only a portion of the full capacity is used. For all anodes of Test Set A, the performance cycling was set to use about a third of the total capacity, i.e., about 1200 mAh/g. The performance cycling protocol included 3C or 1C charging (considered aggressive in the industry) and C/3 discharging to roughly a 20% state of charge. A 10-minute rest was provided between charging and discharging cycles.

Table 2 summarizes the properties and cycling performance of Example Anodes E-1A, E-2A, and E-3A. No testing could be made on Comparative Anode C-1A because the silicon did not adhere sufficiently well. In some commercial uses, the anodes should have a charge capacity of at least 1.5 mAh/cm² and be able to charge at a rate of 1C with a cycle life of at least 100 cycles, meaning that the charge capacity should not fall lower than 80% of the initial charge capacity after 100 cycles. The number of cycles it takes for an anode to fall below 80% of the initial charge is commonly referred to as its ″80% SoH (″state-of-health″) cycle life″. All Example Anodes achieved these goals. The boron-doped a-Si in Example Anode E-2 may achieve higher charge capacities and lifetimes in combination with the present surface layer. As shown by example Anode E-3A, the cycle life of Example Anode E-2A can be improved by providing a TiO₂ sublayer over the silicon compound sublayer. Thus, when the surface layer includes a metal oxide sublayer, lifetimes may be improved.

TABLE 2

| Property | E-1A | E-2A | E-3A |
|---|---|---|---|
| Charge rate | 3C | 1C | 1C |
| Active Si (mg/cm²) | 1.4 | 1.6 | 1.7 |
| Initial charge capacity (mAh/cm²) | 1.6 | 2.1 | 2.0 |
| Cycles to 80% of initial charge capacity | 130 | 151 | 224 |

### Test Set B

An Oxford Plasmalabs System 100 PECVD tool was used to deposit silicon onto various current collectors. Unless otherwise noted, depositions were conducted at about 300° C. at an RF power in a range of about 225 to 300 W. The deposition gas was a mixture of silane and argon in a gas flow ratio of about 1 to 12, respectively. For most tests, a deposition time of 40 minutes was used to deposit a layer of porous amorphous silicon about 7 µm thick. For higher loadings, a deposition time of 70 to 75 minutes was used to deposit about 11 to 12 µm. For a few tests, sub-stoichiometric silicon nitride coatings (SiNx) were prepared. Conditions were similar to above but included ammonia gas at a silane-to-ammonia gas flow ratio of about 2.25 to 1, with a 75-minute deposition time to produce about 11 to 12 µm of the SiNx.

Three starting foils were used to prepare current collectors. Copper Foil A (high purity copper) was 25 µm thick, a tensile strength of about 275 MPa, and a surface roughness Rₐ of 167 nm. Copper Foil B (rolled C70250 alloy sometimes referred to as CuNi3Si) was 20 µm thick and had a tensile strength in a range of about 690 to 860 MPa, a yield strength of greater than about 655 MPa, and a surface roughness Rₐ of 280. Nickel Foil A (rolled nickel) was 20 µm and had a tensile strength in a range of about 680 to 750 MPa, a yield strength of greater than about 550 MPa and a surface roughness Rₐ of 279.

Unless otherwise noted, electrodepositions on metal foil were performed using a plating fixture such that just one side of the metal foil was exposed for the electrodeposition. The counter electrode was platinum/niobium mesh spaced 1.9 cm from the metal foil.

The authors have previously found that the above PECVD conditions are ineffective at depositing commercially useful loading of silicon onto freshly cleaned copper or nickel foil surfaces not having a surface layer. The silicon does not adhere and flakes off.

### Comparative Anode C-1B

In this test, it is shown that electrodepositing copper roughening features alone is generally not sufficient to improve adhesion of silicon. Copper Foil A was cleaned first in acetone then in IPA with sonication for 10 minutes then rinsed with DI water. The foil was treated with 10% concentrated sulfuric acid for 30 seconds, rinsed in DI water, and placed in an electrodeposition fixture. The fixture was immersed in a bath of 0.01 M CuSO₄ (aq) with 1 M H₂SO₄. Current was supplied to the foil at 100 mA/cm² for 100 sec (conditions suitable to deposit copper roughening feature), the foil was removed and rinsed in DI water and air dried. The surface roughness Rₐ was 246 nm and surface roughness R_{z} was 2.3 µm. When silicon was deposited by PECVD as described above, it easily flaked off.

### Comparative Anode C-2B

This test is like C-1B, except that following copper roughening feature deposition, the foil was further treated with silicon compound A (3-glycidoxypropyl triethoxysilane). In particular, the foil was placed into a tray and covered with a solution of 1 mL silicon compound A in 180 mL ethanol, and then filled with DI water to 200 mL. The foil was left submerged for 30 seconds and then hung to dry. After dry the foil was placed into an oven at 140° C. for 30 minutes to dry/cure the silicon compound The surface roughness Rₐ was 233 nm and surface roughness R_{z} was 2.0 µm. When silicon was deposited by PECVD as described above, it easily flaked off Thus, on freshly electrodeposited copper, even with copper roughening feature, this silicon compound did not provide an effective surface layer. As shown below, silicon compounds may be effective with chemically roughened copper foil rather than foil roughened electrochemically with electrodeposited copper roughening features.

### Example Anode E-1B

Copper Foil A was cleaned first in acetone then in IPA with sonication for 10 minutes then rinsed with DI water. The foil was treated with 10% concentrated sulfuric acid for 30 seconds, rinsed in DI water, and placed in an electrodeposition fixture. The fixture was immersed in a bath of 0.01 M CuSO₄ (aq) with 1 M H₂SO₄. Current was supplied to the foil at 50 mA/cm² for 200 sec (conditions suitable to deposit copper roughening features). The fixture is then placed into a bath of 0.4 M CuSO₄ (aq) and 1 M H₂SO₄ and supplied with a current density of 10 mA/cm² for a period of 100 seconds. This second copper deposition overcoated the copper roughening features and may help anchor them to the foil. The fixture was then removed rinsed with DI water. Following the rinse, the fixture was placed into a bath of 0.1 M ZnSO₄ and 1 M H₂SO₄ and supplied with a current density of 10 mA/cm2 for 100 seconds. After this the fixture was again rinsed with DI water. The fixture was then placed into a bath of 4 g/L of K₂CrO₄ (pH ~ 12) and supplied with a current density of 10 mA/cm² for 40 seconds. After this the fixture again rinsed with DI water and air dried. The current collector had a surface roughness Rₐ of 418 nm and surface roughness R_{z} of 5.3 µm. An adherent layer of amorphous silicon (a continuous porous lithium storage layer) was deposited by PECVD under conditions noted above for a period of 40 minutes. The surface layer of this example may be characterized as including a first surface sublayer of zinc and a second surface sublayer of a chromium-containing metal-oxygen compound, such surface sublayers provided over a metal foil roughened with electrodeposited copper roughening features.

### Example Anode E-2B

Example Anode E-2B was like E-1B except that following deposition of the chromium-containing metal-oxygen compound, the foil was further treated with silicon compound A (3-glycidoxypropyltriethoxysilane). In particular, the foil was placed into a tray and covered with a solution of 1 mL silicon compound A in 180 mL ethanol, and then filled with DI water to 200 mL. The foil was left submerged for 30 seconds and then hung to dry. After dry the foil was placed into an oven at 140° C. for 30 minutes to dry/cure the silicon compound. The surface roughness Rₐ was 401 nm and surface roughness R_{z} was 4.7 µm. An adherent layer of amorphous silicon (a continuous porous lithium storage layer) was deposited by PECVD under conditions noted above for a period of 40 minutes The surface layer of this example may be characterized as including a first surface layer of zinc, a second surface layer of a chromium-containing metal-oxygen compound, and a third surface layer of a silicon compound, such surface sublayers provided over a metal foil roughened with electrodeposited copper roughening features.

### Example Anode E-3B

Copper Foil A was cleaned first in acetone then in IPA with sonication for 10 minutes then rinsed with DI water. The foil was treated with 10% concentrated sulfuric acid for 30 seconds, rinsed in DI water, placed in a tray of an MSA roughening bath for 10 seconds with gentle swirling. The MSA roughening bath was composed of composed of 40 g/L H₂O₂, 100 g/L methanesulfonic acid (MSA), 3 g/L 5-aminotetrazole, and 8 g/L benzotriazole. The foil was removed for a short period, quenched in DI water, and then re-immersed in the MSA bath. A total of six (6) 10 sec immersions were conducted, sufficient to impart some surface roughening. The foil was rinsed with DI water and air dried. It is expected that air drying forms at least a monolayer of an oxide of copper, perhaps more. The foil was then placed into a tray and covered with a mixture including silicon compound A (100 µL) and tetrabutylammonium molybdate (0.0322 g) in 10 mL dichloromethane with 100 µL of added water. The foil was left submerged for 30 seconds and then hung to dry. After dry the foil was placed into an oven at 140° C. for 30 minutes to dry/cure the silicon compound / molybdate mixture. The surface roughness Ra was 723 nm and surface roughness R_{z} was 10.3 µm. An adherent layer of amorphous silicon (a continuous porous lithium storage layer) was deposited by PECVD under conditions noted above for a period of 40 minutes. The surface layer of this example may be characterized as including a first surface sublayer of a copper oxide and a second surface sublayer including a mixture of a transition metallate (molybdate) and a silicon compound, such surface sublayers provided over a chemically roughened copper foil.

### Example Anode E-4B

Example Anode E-4B was similar to E-3B except that after the MSA bath treatment, the foil was further treated with silicon compound B (3-aminopropyltriethoxysilane). In particular, the foil was placed into a tray and covered with a solution of 1 mL silicon compound B in 180 mL ethanol, and then filled with DI water to 200 mL. The foil was left submerged for 30 seconds and then hung to dry. After dry the foil was placed into an oven at 140° C. for 30 minutes to dry/cure the silicon compound The surface roughness Rₐ was 902 nm and surface roughness R_{z} was 12.5 µm. An adherent layer of amorphous silicon (a continuous porous lithium storage layer) was deposited by PECVD under conditions noted above for a period of 40 minutes. The surface layer of this example may be characterized as including a first surface sublayer of a copper oxide and a second surface sublayer having a silicon compound, such surface sublayers provided over a chemically roughened copper foil.

### Example Anode E-5B

Copper Foil A was cleaned first in acetone then in IPA with sonication for 10 minutes then rinsed with DI water. The foil was treated with 10% concentrated sulfuric acid for 30 seconds, rinsed in DI water, and placed in an electrodeposition fixture. The fixture was immersed in a bath of 0.01 M CuSO₄ (aq) with 1 M H₂SO₄. Current was supplied to the foil at 20 mA/cm² for 500 sec (conditions suitable to deposit copper roughening features). The fixture was then placed into a bath of 0.4 M CuSO₄ (aq) and 1 M H₂SO₄ and supplied with a current density of 10 mA/cm² for a period of 100 seconds. This second copper deposition overcoated the copper roughening features and may help anchor them to the foil. The fixture was then removed rinsed with DI water. Following the rinse, the fixture was placed into a bath of 0.26 M ZnCl₂, 0.13 M NiC1₂ and 1 M KC1, with pH adjusted to about 5, and supplied with a current density of 10 mA/cm2 for 100 seconds. After this the fixture was again rinsed with DI water. The fixture was then placed into a bath of 4 g/L of K₂CrO₄ (pH ~ 12) and supplied with a current density of 10 mA/cm² for 40 seconds. After this the fixture again rinsed with DI water and air dried. The current collector had a surface roughness Ra of 254 nm and surface roughness R_{z} of 2.5 µm. An adherent layer of amorphous silicon (a continuous porous lithium storage layer) was deposited by PECVD under conditions noted above for a period of 75 minutes. The surface layer of this example may be characterized as including a first surface sublayer of a zinc-nickel alloy and a second surface sublayer of a chromium-containing metal-oxygen compound, such surface sublayers provided over a metal foil roughened with electrodeposited copper roughening features. The zinc-nickel alloy included about 8 - 9 atomic % nickel.

### Example Anode E-6B

Nickel Foil A was cleaned first in acetone then in IPA with sonication for 10 minutes then rinsed with DI water. The foil was treated with 10% concentrated sulfuric acid for 30 seconds, rinsed in DI water, and placed in an electrodeposition fixture. The fixture was immersed in a bath of 0.01 M CuSO₄ (aq) with 1 M H₂SO₄. Current was supplied to the foil at 100 mA/cm² for 100 sec (conditions suitable to deposit copper roughening features). The fixture was then placed into a bath of 0.4 M CuSO₄ (aq) and 1 M H₂SO₄ and supplied with a current density of 10 mA/cm² for a period of 100 seconds. This second copper deposition overcoated the copper roughening features and may help anchor them to the foil The fixture was then removed rinsed with DI water. Following the rinse, the fixture was placed into a bath of 0.1 M ZnSO₄ and 1 M H₂SO₄ and supplied with a current density of 10 mA/cm² for 100 seconds. After this the fixture was again rinsed with DI water. The fixture was then placed into a bath of 4 g/L of K₂CrO₄ (pH ~ 12) and supplied with a current density of 10 mA/cm² for 40 seconds. After this the fixture was again rinsed with DI water and air dried. The current collector had a surface roughness Ra of 464 nm and surface roughness R_{z} of 5.0 µm. An adherent layer of amorphous silicon (a continuous porous lithium storage layer) was deposited by PECVD under conditions noted above for a period of 40 minutes. The surface layer of this example may be characterized as including a first surface sublayer of a zinc and a second surface sublayer of a chromium-containing metal-oxygen compound, such surface layers provided over a nickel foil roughened with electrodeposited copper roughening features.

### Example Anode E-7B

Example Anode E-7B was like E-6B except that following deposition of the chromium-containing metal-oxygen compound, the foil was further treated with silicon compound A (3-glycidoxypropyltriethoxysilane). In particular, the foil was placed into a tray and covered with a solution of 1 mL silicon compound A in 180 mL ethanol, and then filled with DI water to 200 mL. The foil was left submerged for 30 seconds and then hung to dry. After dry the foil was placed into an oven at 140° C. for 30 minutes to dry/cure the silicon compound. The surface roughness Rₐ was 409 nm and surface roughness R_{z} was 4.6 µm. An adherent layer of amorphous silicon (a continuous porous lithium storage layer) was deposited by PECVD under conditions noted above for a period of 40 minutes. The surface layer of this example may be characterized as including a first surface sublayer of a zinc and a second surface sublayer of a chromium-containing metal-oxygen compound, and a third surface layer of a silicon compound, such surface layers provided over a nickel foil roughened with electrodeposited copper roughening features.

### Example Anode E-8B

Copper Foil B was cleaned first in acetone then in IPA with sonication for 10 minutes then rinsed with DI water. The foil was placed in an oven (in air) at 180° C. for 15 hours. The foil was covered with 10% sulfuric acid for 5 min to remove at least some of the oxides the developed during the oven treatment. The foil was rinsed in DI water and placed in an electrodeposition fixture. The fixture was immersed in a bath of 0.001 M CuSO₄ (aq) with 1 M H₂SO₄. Current was supplied to the foil at 10 mA/cm² for 100 sec (conditions suitable to deposit copper roughening features). The fixture was then placed into a bath of 0.4 M CuSO₄ (aq) and 1 M H₂SO₄ and supplied with a current density of 10 mA/cm² for a period of 100 seconds. This second copper deposition overcoated the copper roughening features and may help anchor them to the foil. The fixture was then removed rinsed with DI water. Following the rinse, the fixture was placed into a bath of 0.1 M ZnSO₄ and 1 M H₂SO₄ and supplied with a current density of 10 mA/cm² for 100 seconds. After this the fixture was again rinsed with DI water. The fixture was then placed into a bath of 4 g/L of K₂CrO₄ (pH ~ 12) and supplied with a current density of 10 mA/cm² for 40 seconds. After this the fixture again rinsed with DI water and air dried. The current collector had a surface roughness Ra of 453 nm and surface roughness R_{z} of 5.2 µm. An adherent layer of amorphous silicon (a continuous porous lithium storage layer) was deposited by PECVD under conditions noted above for a period of 40 minutes. The surface layer of this example may be characterized as including a first surface sublayer of zinc and a second surface sublayer of a chromium-containing metal-oxygen compound, such surface sublayers provided over a nickel foil roughened with electrodeposited copper roughening features.

### Example Anode E-9B

Copper Foil B was cleaned first in acetone then in IPA with sonication for 10 minutes then rinsed with DI water. The foil was placed in an oven (in air) at 180° C. for 15 hours. The foil was covered with 10% sulfuric acid for 5 min to remove at least some of the oxides the developed during the oven treatment. The foil was rinsed in DI water and placed into a tray and treated for 30 sec in a peroxide/HCl solution (10 mL 30% H₂O₂, 240 mL DI water, 50 mL concentrated HCI) with gentle swirling. The foil was rinsed with DI water and air dried. It is expected that air drying forms at least a monolayer of an oxide of copper, perhaps more. The foil was further treated with silicon compound A (3-glycidoxypropyl triethoxysilane). In particular, the foil was placed into a tray and covered with a solution of 1 mL silicon compound A in 180 mL ethanol, and then filled with DI water to 200 mL. The foil was left submerged for 30 seconds and then hung to dry. After dry the foil was placed into an oven at 140° C. for 30 minutes to dry/cure the silicon compound. The surface roughness Ra was 591 nm and surface roughness R_{z} was 11.4 µm. An adherent layer of amorphous silicon (a continuous porous lithium storage layer) was deposited by PECVD under conditions noted above for a period of 40 minutes. The surface layer of this example may be characterized as including a first surface sublayer of a copper oxide and a second surface sublayer having a silicon compound, such surface sublayers provided over a chemically roughened copper foil.

### Example Anode E-10B

Copper Foil B was cleaned first in acetone then in IPA with sonication for 10 minutes then rinsed with DI water. The foil was placed in an oven (in air) at 180° C. for 20 mins. The foil was covered with 10% sulfuric acid for 30, rinsed in DI water, and placed in an electrodeposition fixture. The fixture was immersed in a bath of 0.01 M CuSO₄ (aq) with 1 M H₂SO₄. Current was supplied to the foil at 20 mA/cm² for 500 sec (conditions suitable to deposit copper roughening features). The fixture was then placed into a bath of 0.4 M CuSO₄ (aq) and 1 M H₂SO₄ and supplied with a current density of 10 mA/cm² for a period of 100 seconds. This second copper deposition overcoated the copper roughening features and may help anchor them to the foil. The fixture was then removed rinsed with DI water. Following the rinse, the fixture was placed into a bath of 0.26 M ZnCl₂, 0.13 M NiCl₂ and 1 M KCl, with pH adjusted to about 5, and supplied with a current density of 10 mA/cm² for 100 seconds. After this the fixture was again rinsed with DI water. The fixture was then placed into a bath of 4 g/L of K₂CrO₄ (pH ~ 12) and supplied with a current density of 10 mA/cm² for 40 seconds. After this the fixture again rinsed with DI water and air dried. The surface roughness was not measurable optically. An adherent layer of amorphous silicon (a continuous porous lithium storage layer) was deposited by PECVD under conditions noted above for a period of 70 minutes. The surface layer of this example may be characterized as including a first surface sublayer of a zinc-nickel alloy and a second surface sublayer of a chromium-containing metal-oxygen compound, such surface sublayers provided over a metal foil roughened with electrodeposited copper roughening features. The zinc-nickel alloy included about 8 - 9 atomic % nickel.

### Example Anode E-11B

Copper Foil B was cleaned first in acetone then in IPA with sonication for 10 minutes then rinsed with DI water. The foil was placed in an oven (in air) at 180° C. for 20 mins. The foil was covered with 10% sulfuric acid for 30, rinsed in DI water, and placed in an electrodeposition fixture. The fixture was immersed in a bath of 0.01 M CuSO₄ (aq) with 1 M H₂SO₄. Current was supplied to the foil at 50 mA/cm² for 200 sec (conditions suitable to deposit copper roughening features). The fixture was then placed into a bath of 0.4 M CuSO₄ (aq) and 1 M H₂SO₄ and supplied with a current density of 10 mA/cm² for a period of 100 seconds. This second copper deposition overcoated the copper roughening features and may help anchor them to the foil. The fixture was then removed rinsed with DI water. Following the rinse, the fixture was placed into a bath of 0.1 M ZnSO₄ and 1 M H₂SO₄ and supplied with a current density of 10 mA/cm² for 100 seconds. After this the fixture was again rinsed with DI water. The fixture was then placed into a bath of 4 g/L of K₂CrO₄ (pH ~ 12) and supplied with a current density of 10 mA/cm² for 40 seconds. The fixture again rinsed with DI water and air dried. The surface roughness Rₐ was 418 nm and surface roughness R_{z} was 5.3 µm. An adherent layer of amorphous silicon (a continuous porous lithium storage layer) was deposited by PECVD under conditions noted above for a period of 70 minutes. The surface layer of this example may be characterized as including a first surface sublayer of a zinc and a second surface sublayer of a chromium-containing metal-oxygen compound, such surface sublayers provided over a metal foil roughened with electrodeposited copper roughening features.

### Example Anode E-12B

Example Anode E-12B was like E-11B except that following deposition of the chromium-containing metal-oxygen compound, the foil was further treated with silicon compound A (3-glycidoxypropyltriethoxysilane). In particular, the foil was placed into a tray and covered with a solution of 1 mL silicon compound A in 180 mL ethanol, and then filled with DI water to 200 mL. The foil was left submerged for 30 seconds and then hung to dry. After dry the foil was placed into an oven at 140° C. for 30 minutes to dry/cure the silicon compound. The surface roughness Ra was 344 nm and surface roughness R_{z} was 3.9 µm. An adherent layer of amorphous silicon (a continuous porous lithium storage layer) was deposited by PECVD under conditions noted above for a period of 40 minutes. The surface layer of this example may be characterized as including a first surface layer of zinc, a second surface layer of a chromium-containing metal-oxygen compound, and a third surface layer of a silicon compound, such surface sublayers provided over a metal foil roughened with electrodeposited copper roughening features.

### Example Anode E-13B

Current collector sample CC-1B was an 18 µm thick commercially available copper foil having a surface roughness of Rₐ = 508 nm and R_{z} = 5.2 µm. Based on product literature and analytical data, CC-1B is believed to include a surface layer of the present disclosure having a first surface sublayer of zinc and a second surface sublayer of a metal-oxygen compound including chromium. As illustrated later with some SEMs, the surface has some roughness, but CC-1B does not generally include electrodeposited roughening features. An adherent layer of amorphous silicon (a continuous porous lithium storage layer) was deposited by PECVD under conditions noted above for a period of 40 minutes. The surface layer of this example may be characterized as including a first surface sublayer of a zinc and a second surface sublayer of a chromium-containing metal-oxygen compound, such surface sublayers provided over a rough copper foil not having electrodeposited copper roughening features.

### Example Anode E-14B

Copper Foil A was cleaned first in acetone then in IPA with sonication for 10 minutes then rinsed with DI water. The foil was treated with 10% concentrated sulfuric acid for 30 seconds, rinsed in DI water, and placed in an electrodeposition fixture. The fixture was immersed in a bath of 0.01 M CuSO₄ (aq) with 1 M H₂SO₄. Current was supplied to the foil at 20 mA/cm² for 500 sec (conditions suitable to deposit copper roughening features). The fixture was then placed into a bath of 0.4 M CuSO₄ (aq) and 1 M H₂SO₄ and supplied with a current density of 10 mA/cm² for a period of 100 seconds. This second copper deposition overcoated the copper roughening features and may help anchor them to the foil. The fixture was then removed rinsed with DI water. Following the rinse, the fixture was placed into a bath of 0.26 M ZnCl₂, 0.13 M NiCl₂ and 1 M KCI, with pH adjusted to about 5, and supplied with a current density of 10 mA/cm² for 100 seconds. After this the fixture was again rinsed with DI water. The fixture was then placed into a bath of 4 g/L of K₂CrO₄ (pH ~ 12) and supplied with a current density of 10 mA/cm² for 40 seconds. After this, the fixture again rinsed with DI water and air dried. The current collector had a surface roughness Rₐ of 254 nm and surface roughness R_{z} of 2.5 µm. An adherent layer of a sub-stoichiometric silicon nitride (a continuous porous lithium storage layer) was deposited by PECVD under conditions noted above for a period of 70 minutes. The surface layer of this example may be characterized as including a first surface sublayer of a zinc-nickel alloy and a second surface sublayer of a chromium-containing metal-oxygen compound, such surface sublayers provided over a metal foil roughened with electrodeposited copper roughening features. The zinc-nickel alloy included about 8 - 9 atomic % nickel.

### Example Anode E-15B

Example Anode E-16B was the same as E-14B except that a sub-stoichiometric silicon nitride (a continuous porous lithium storage layer) was deposited by PECVD under conditions noted above for a period of 70 minutes. The surface layer of this example may be characterized as including a first surface sublayer of a zinc and a second surface sublayer of a chromium-containing metal-oxygen compound, such surface sublayers provided over a rough copper foil not having electrodeposited copper roughening features.

### Example Anode

Current collector sample CC-2B was an 18 µm thick commercially available copper foil having a surface roughness of Rₐ = 580 nm and R_{z} = 6.0 µm. Based on product literature and analytical data, CC-2B is believed to include a first surface sublayer of zinc, a second surface sublayer of a metal-oxygen compound including chromium, and a third surface sublayer of a silicon compound. The chemical structure the silicon compound was not known (″Si cpd X″). A layer of amorphous silicon (a continuous porous lithium storage layer) was deposited by PECVD under conditions noted above for a period of 65 minutes. In electrochemical testing (see below and Table 3), although this anode has very good capacity, the cycle life was generally not as good as other examples.

### Sem Analysis

FIGS. 8 - 11 illustrate the topology of the various current collectors discussed above. The current collector from Example E-14B is representative of current collectors having electrodeposited copper roughening features. FIG. 8A shows a top-down view and FIG. 8B is a cross-sectional view. These roughening features may be characterized as nanopillar features as described previously. The features are quite dense, relatively small, mostly pointing 60 to 90 degrees relative to the foil, and there are relatively few where their ″tops″ are significantly wider than their base. Most of these features may be characterized as first-type nanopillar features. FIG. 8C shows the anode of Example E-14B. As can be seen, the electrodeposited copper roughening features (nanopillar features) may have the proper geometry to become generally embedded in the SiNx layer. This may aid in the adherence of the continuous porous lithium storage layer. This current collector surface structure may induce some void spaces at the current collector — SiNx interface. This may allow for additional room for swell of silicon during lithiation cycles and reduce structural degradation. Although not shown here, similar images are observed using amorphous silicon rather than SiNx.

The current collector of example E-16B (CC-2B) is shown in cross section in FIG. 9. Although there are a number of features that are similar to FIG. 8B, there are many features where their tops are significantly wider than the base (second-type nanopillars, circled in the figure). As mentioned, the electrochemical performance of anodes using this current collector may be acceptable, but such anodes are often inferior to others of the present disclosure. The reason is not fully understood, but other current collectors having similar physical properties (wide ″tops″) have also been found not to perform well. Not being bound by theory, it may be that the wide tops prevent the roughening features from becoming embedded in the silicon. Alternatively, these structures may be structurally fragile and may break at the base. Regardless, current collectors having too many of such structures may in some embodiments not perform well with PECVD-deposited lithium storage materials.

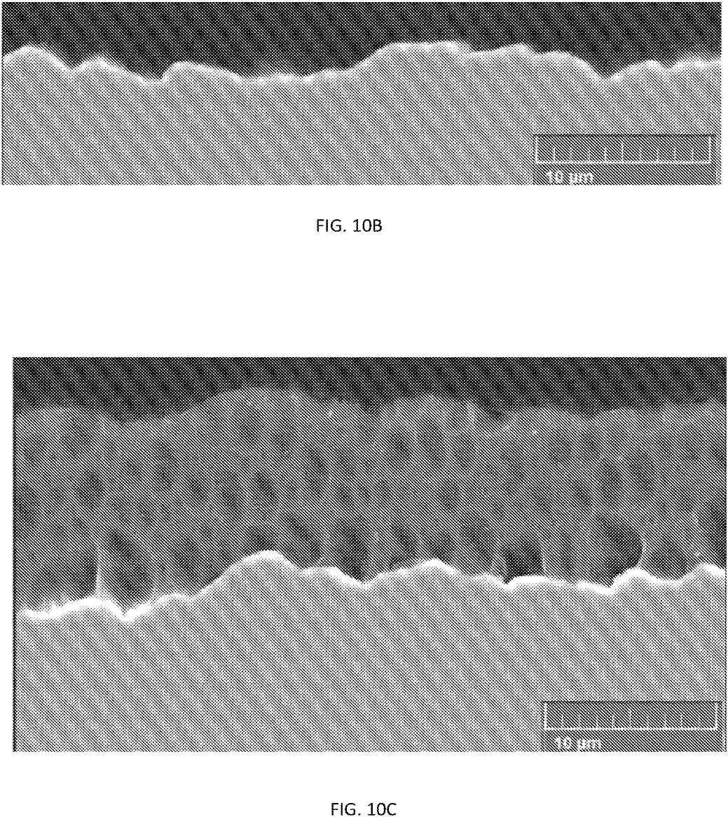

The current collector of examples E-14B and E-16B is shown in FIG. 10. FIG. 10A is a 45-degree view of the surface and FIG. 10B is a cross-sectional view. There is clearly roughness, but no fine roughening features such as nanopillars or the like. The current collector may be considered a representative example of one with broad roughness features characterized by bumps and hills as discussed previously. FIG. 10C is a cross-section of example anode E-16B further illustrating the profile. Unlike example E-14B (FIG. 8C), this current collector did not appear to induce void spaces within the SiNx continuous porous lithium storage layer at its interface.

The current collector of example E-3B is shown in FIG. 11 in a 45-degree perspective view. The chemically roughened (etched) current collectors appear quite different than the other current collectors. In some cases, they may be characterized as having pits or craters that create significant roughness. These pits and related structures may form strong anchor points for the continuous porous lithium storage layer.

### Electrochemical Testing - Half Cells

Half cells were constructed using a 0.80 cm diameter punch of each anode. Lithium metal served as the counter electrode which was separated from the test anode using Celgard™ separators. The standard electrolyte solution (″standard″) included: a) 88 wt.% of 1.2 M LiPF₆ in 3:7 EC:EMC (weight ratio); b) 10 wt.% FEC; and 2 wt.% VC. Some testing was performed using a commercial electrolyte very similar to the standard, but with one or more additives (proprietary to the supplier). Anodes first underwent an electrochemical formation step. As is known in the art, the electrochemical formation step is used to form an initial SEI layer. Relatively gentle conditions of low current and/or limited voltages may be used to ensure that the anode is not overly stressed. In the present examples, electrochemical formation included several cycles over a wide voltage range (0.01 or 0.06 to 1.2 V) at C-rates ranging from C/20 to C/10. The total active silicon (mg/cm²) available for reversible lithiation and total charge capacity (mAh/cm²) were determined from the electrochemical formation step data. Formation losses were calculated by dividing the change in active areal charge capacity (initial first charge capacity minus last formation discharge capacity) by the initial areal first charge capacity. While silicon has a theoretical charge capacity of about 3600 mAh/g when used in lithium-ion batteries, it has been found that cycle life may improve if only a portion of the full capacity is used. For all anodes, the performance cycling was set to use a portion of the total capacity, typically in a range of 950 - 1700 mAh/g. The performance cycling protocol included 3.2C or 1C charging (considered aggressive in the industry) and C/3 discharging to roughly a 15% state of charge. A 10-minute rest was provided between charging and discharging cycles.

Table 3 summarizes the properties and cycling performance of Comparative and Example Anodes from Test Set B. Note that a surface sublayer having a chromium-containing metal-oxygen compound is simply noted as “CrOx” and copper oxide surface sublayer is simply noted as “CuOx”. No testing could be made on Comparative Anodes C-1 or C-2 because the silicon did not adhere sufficiently well. Comparative Anode C-3B failed during electrochemical formation and so was not cycled.

In some commercial uses, the anodes should have a charge capacity of at least 1.5 mAh/cm² and be able to charge at a rate of 1C with a cycle life of at least 100 cycles, meaning that the charge capacity should not fall lower than 80% of the initial charge capacity after 100 cycles. The number of cycles it takes for an anode to fall below 80% of the initial charge is commonly referred to as its ″80% SoH (″state-of-health″) cycle life″. All Example Anodes achieved these goals. One sample (E-1B) cycled for >1000 cycles and was still going before being removed from the test cycler. Several have achieved > 500 cycles, some of which are still cycling. It is noted also that the formation losses for all of the a-Si samples were very low. It has often been observed that high formation losses may be indicative of an unstable anode (although there may be exceptions to this rule). In general, formation losses of less than 15% are considered very good and may sometimes be indicative of a stable a-Si anode.

For surface layers including zinc and a chromium-containing metal-oxygen compound sublayers, it appears that anodes may perform better without the additional silicon compound sublayer (E-1B vs E-2B, E-6B vs E-7B, and E-18B vs E-12B). Such anodes with the silicon compound (third surface sublayer) may have good performance with respect to cycle life, but generally not as good anodes using current collectors that exclude the silicon compound layer. Although the use of silicon compounds for coating battery foils may be common for conventional slurry-based anodes, in some cases, anodes based on PECVD deposited lithium storage layers are advantaged when the third surface sublayer of the silicon compound is not present.

It has generally been observed that the use of a zinc-nickel alloy as the first surface sublayer (with a chromium-containing metal-oxygen compound second surface sublayer) may provide more reliable performance at higher silicon loadings and/or higher charge rates than similar anodes using pure or nearly pure zinc instead of the alloy (e.g., E-10B vs E-11B). However, as can be seen, there are many examples of excellent-performing cells using pure or nearly pure zinc.

In general, anodes using zinc-based first surface sublayer and the chromium-containing oxygen metal compound second surface sublayer had the best performance when the current collector roughening treatment included electrodeposited copper roughening features (e.g., nanopillar type structures as discussed above) as compared to broader or less finely structured roughness structures (e.g., bumps and hills) - E-8B vs E-13B or E-14B vs E15B.

For SiNx samples, there is a larger loss in formation due to the nitrogen doping, but despite this, anodes using SiNx were successfully fabricated having very high charge capacity (3 mAh/cm²) with high cycle life (up to 518 cycles) and fast 1C charge rates. In some embodiments, anodes based on SiNx may show less swell than those based on a-Si.

For chemically roughened samples, it has been found that a simple layer of a silicon compound over the copper (generally having at least a monolayer of surface copper oxide material) was often sufficient to provide a good performing anode. These samples (E-3B, E-4B, E-9B) required no electrochemical steps and so may be simpler to manufacture. In some cases, addition of a metal-oxygen compound (e.g., an oxometallate such as molybdate) to the silicon compound (E-3B) may provide additional cycle life benefits.

In some embodiments, anodes of the present disclosure may provide at least a charge capacity of at least 1.6 mAh/cm² and an 80% SoH cycle life of at least 150 cycles at a charge rate of at least 1C and a discharge rate of at least C/3. In some embodiments, anodes of the present disclosure may have a cycle life of at least 300 cycles, alternatively at least 400, 500, 600, 700, 800, 900, or 1000 cycles when tested at 1.7 mAh/cm2 at 1C charge and C/3 discharge. In some embodiments, anodes of the present disclosure may be capable of providing a charge capacity of 3 mAh/cm2 with an 80% SoH cycle life of at least 150 cycles at 1C charging and C/3 discharging, alternatively at least 300 cycles, or at least 500 cycles. In some embodiments, anodes of the present disclosure may be capable of charging at 3C with a charge capacity of 2 mAh/cm2 and an 80% SoH cycle life of at least 400 cycles.

TABLE 3

| Ex. | Foil | Rough type^{†} | Rₐ | 1^{st} surf. sublayer | 2^{nd} surf. sublayer | 3^{rd} surf. sublayer | Storage layer | Charge rate | Capacity (mAh/cm²) | Form. losses | Cycle life |
|---|---|---|---|---|---|---|---|---|---|---|---|
| C-1B | Cu Foil A | 1 | 246 | CuOx | n/a | n/a | Failed — a-Si did not adhere | | | | |
| C-2B | Cu Foil A | 1 | 233 | CuOx | Si cpd A | n/a | Failed — a-Si did not adhere | | | | |
| E-1B | Cu Foil A | 1 | 418 | Zn | CrOx | n/a | a-Si | 1C^ | 1.7 | 6% | >1000 |
| E-2B | Cu Foil A | 1 | 401 | Zn | CrOx | Si cpd A | a-Si | 1C^ | 1.7 | 8% | 338 |
| E-3B | Cu Foil A | 2 | 723 | CuOx | Si cpd A & molybdate | n/a | a-Si | 1C | 1.7 | 8% | 685^{∗} |
| E-4B | Cu Foil A | 2 | 902 | CuOx | Si cpd B | n/a | a-Si | 1C^ | 1.7 | 9% | 329 |
| E-5B | Cu Foil A | 1 | 254 | Zn-Ni | CrOx | n/a | a-Si | 3.2C | 2.2 | 8% | 599 |
| E-6B | Ni Foil A | 1 | 389 | Zn | CrOx | n/a | a-Si | 1C^ | 1.7 | 7% | 720 |
| E-7B | Ni Foil A | 1 | 409 | Zn | CrOx | Si cpd A | a-Si | 1C^ | 1.7 | 7% | 232 |
| E-8B | Cu Foil B | 1 | 453 | Zn | CrOx | n/a | a-Si | 1C | 1.7 | 7% | 751^{∗} |
| E-9B | Cu Foil B | 2 | 591 | CuOx | Si cpd A | n/a | a-Si | 1C | 1.7 | 11% | 582 |
| E10B | Cu Foil B | 1 | unk | Zn-Ni | CrOx | n/a | a-Si | 3.2C | 2.2 | 10% | 632 |
| E11B | Cu Foil B | 1 | 418 | Zn | CrOx | n/a | a-Si | 3.2C | 2.2 | 10% | 404 |
| E12B | Cu Foil B | 1 | 344 | Zn | CrOx | Si cpd A | a-Si | 1C | 1.7 | 12% | 641 |
| E13B | CC-1B | 3 | 508 | Zn | CrOx | n/a | a-Si | 1C | 1.7 | 8% | 170 |
| E14B | Cu Foil A | 1 | 254 | Zn-Ni | CrOx | n/a | SiNx | 1C | 3.0 | 24% | 518 |
| E15B | CC-1B | 3 | 508 | Zn | CrOx | n/a | SiNx | 1C | 3.0 | 20% | 177 |
| E16B | CC-2B | 4 | 580 | Zn | CrOx | Si cpd X | a-Si | 1C^ | 3.0 | 15% | 97 |

^{†}1 = electrodeposited copper roughening features (e.g., nanopillars); 2 = chemical roughening (e.g., pits); 3 = broad roughness features (e.g., bumps/hills); 4 = wide-top roughening features
^{∗} Still cycling
^ A commercial electrolyte used

It should be noted that anodes using Copper Foil A, even though the cells were often stable during cycling, were prone to deform during cycling. For example, wrinkles in the foil upon disassembly were often noted at these silicon loadings. It may be that the expansion and contraction of the silicon at these high loadings imparted stress to Copper Foil A to cause these deformations. Copper Foil A has a relatively low tensile strength. Surprisingly, the anodes performed well in cycling despite the deformations. Nevertheless, in some battery applications, such deformations may be problematic. It was found that examples using high tensile Copper Foil B or Nickel Foil A did not have such deformations or the issue was much reduced.

### Test Set C

### Example E-1C

In this test, prelithiated anode was tested in a full cell format. In particular, the same anode as described in Example E-15B was used. Prior to full cell assembly, the anode like that described in Example E-15B was built into a half coin cell with lithium metal as the counter electrode, a Celgard™ separator and commercial electrolyte. The anode was then electrochemically charged (prelithiated) to about 2.2 mAh/cm². The amount of prelithiation was determined by adding the anode formation losses (previously determined by half-cell formation tests) and the desired anode lithium inventory (about 15%), and then subtracting the expected permanent losses of the cathode that was to be paired with the prelithiated anode. After prelithiation, the anode was removed from the half-cell and reassembled into a full coin cell along with an NMC-based cathode (rated at about 4 mAh/cm²) along with a fresh separator and electrolyte (commercial).

The newly built cell was rested 16 hours then electrochemically formed under slow cycling rates between about 2.5 and 4.2 V. The cell was rated at an initial charge capacity of about 3 mAh/cm² then cycled at 1C (to 4.05 V with a C/20 current cut-off), followed by a 10-minute rest, then a C/3 discharge to 2.8 V, followed by a 10-minute rest. At this writing, full cell Example E-1C has received 233 cycles and the initial charge capacity of 3.27 mAh/cm² has fallen to only 2.93 mAh/cm² (~90% SoH).

Example E-1C shows that the strong cycling performance of the present anodes is not limited to just half cell format. Further, example E-1C illustrates that the present anodes may be successfully prelithiated.

In some embodiments, current collectors of the present disclosure may be used with PECVD deposition methods that may deposit a lithium storage layer having at least 40 atomic % silicon, germanium, or a combination thereof, wherein such lithium storage layer may be characterized as other than a continuous porous lithium storage layer. In some embodiments, current collectors of the present disclosure may be used with coatable lithium storage materials, e.g., those containing a carbon-based binder and silicon-containing particles. In some embodiments, current collectors of the present disclosure may be used with sputter-deposited lithium storage material such as sputter-deposited silicon. In some embodiments, current collectors of the present disclosure may be used with substantially non-porous silicon (e.g., having a density higher than 2.95 g/cm³) such as crystalline silicon, polycrystalline silicon, or high-density amorphous silicon.

Although the present anodes have been discussed with reference to batteries, in some embodiments the present anodes may be used in hybrid lithium-ion capacitor devices.

Still further embodiments herein include the following enumerated embodiments.

1. An anode for an energy storage device, the anode comprising:
a) a current collector comprising an electrically conductive layer and a surface layer disposed over the electrically conductive layer, the surface layer comprising a first surface sublayer proximate the electrically conductive layer and a second surface sublayer disposed over the first surface sublayer, wherein:
   (i) the first surface sublayer comprises zinc,
   (ii) the second surface sublayer comprises a metal-oxygen compound, wherein the metal-oxygen compound comprises a transition metal other than zinc, and
   (iii) the current collector is characterized by a surface roughness Ra ≥ 250 nm; and
b) a continuous porous lithium storage layer overlaying the surface layer, wherein the continuous porous lithium storage layer:
   (i) has an average thickness of at least 7 µm,
   (ii) comprises at least 40 atomic % silicon, germanium, or a combination thereof, and
   (iii) is substantially free of carbon-based binders.

2. The anode of embodiment 1, wherein the surface layer further comprises a third surface sublayer provided over the second surface sublayer, the third surface sublayer comprising a silicon compound.

3. The anode of embodiment 2, wherein the silicon compound comprises, or is derived from, a siloxane, a siloxysilane, or a silazane.

4 The anode of embodiment 2 or 3, wherein the surface layer further comprises a fourth surface sublayer provided over the third surface sublayer, the fourth surface sublayer comprising a metal oxide.

5. The anode of embodiment 4, wherein the metal oxide is a transition metal oxide.

6. The anode of embodiment 4, wherein the metal oxide comprises an oxide of titanium, vanadium, chromium, manganese, iron, cobalt, nickel, copper, zinc, molybdenum, tungsten, silver, zirconium, hafnium, tin, aluminum, indium, or niobium.

7. The anode of embodiment 1, wherein the surface layer does not include a silicon compound.

8. The anode of embodiment 1 or 7, wherein the surface layer further comprises a third surface sublayer provided over the second surface sublayer, the third surface sublayer comprising a metal oxide.

9. The anode of embodiment 8, wherein the metal oxide is a transition metal oxide.

10. The anode of embodiment 8, wherein the metal oxide comprises an oxide of titanium, vanadium, chromium, manganese, iron, cobalt, nickel, copper, zinc, molybdenum, tungsten, silver, zirconium, hafnium, tin, aluminum, indium, or niobium.

11. The anode according to any of embodiments 1 - 10, wherein the first surface sublayer comprises at least 98 atomic % zinc relative to all metal atoms in the first surface sublayer.

12. The anode according to any of embodiments 1 - 10, wherein the first surface sublayer comprises a zinc alloy.

13. The anode of embodiment 12, wherein the first surface sublayer comprises less than 98 atomic % zinc relative to all metal atoms in the first surface sublayer.

14. The anode of embodiment 12 or 13, wherein the zinc alloy comprises zinc and nickel.

15. The anode of embodiment 14, wherein the first surface sublayer comprises 3 to 30 atomic % nickel.

16. The anode according to any of embodiments 1 - 15, wherein the first surface sublayer comprises zinc in a range of 10 to 3000 mg/m^{2.}

17. The anode of embodiment 11, wherein the first surface sublayer comprises zinc in a range of 10 to 100 mg/m².

18. The anode according to any of embodiments 12 - 15, wherein the first surface sublayer comprises zinc in a range of 500 to 3000 mg/m².

19. The anode according to any of embodiments 1 - 18, wherein the metal-oxygen compound comprises a metal oxide.

20. The anode according to any of embodiments 1 - 19, wherein the metal-oxygen compound comprises an oxometallate.

21. The anode according to any of embodiments 1 - 20, wherein the transition metal of the metal-oxygen compound comprises titanium, vanadium, chromium, manganese, iron, cobalt, nickel, molybdenum, tungsten, zirconium, or niobium.

22. The anode according to any of embodiments 1 - 20, wherein the transition metal of the metal-oxygen compound comprises chromium.

23. The anode of embodiment 22, wherein the second surface sublayer comprises chromium in a range of 2 to 50 mg/m².

24. The anode according to any of embodiments 1 - 23, wherein the current collector further comprises a plurality of nanopillar features disposed over the electrically conductive layer, wherein each of the plurality of nanopillar features comprises a copper-containing nanopillar core and the surface layer is at least partially over the copper-containing nanopillar core.

25. The anode of embodiment 24, wherein the nanopillar features are each characterized by a height H, a base width B, and a maximum width W, and wherein an average 20 µm long cross section of the current collector comprises:
(i) at least five first-type nanopillars, each first-type nanopillar characterized by
   A) H in a range of 0.4 µm to 3.0 µm,
   B) B in a range of 0.2 µm to 1.0 µm,
   C) a W/B ratio in a range of 1 to 1.5,
   D) an H/B aspect ratio in a range of 0.8 to 4.0, and
   E) an angle of a longitudinal axis relative to the plane of the electrically conductive layer in a range of 60° to 90°; and
(ii) fewer than four second-type nanopillars, each second-type nanopillar characterized by
   A) H of at least 1.0 µm, and
   B) a W/B ratio greater than 1.5.

26. The anode of embodiment 24 or 25, wherein the continuous porous lithium storage layer includes voids within 5 µm of the interface with the nanopillar features.

27. The anode according to any of embodiments 1 - 27, wherein the electrically conductive layer comprises nickel in a nickel layer.

28. The anode of embodiment 27, wherein the electrically conductive layer further comprises a metal interlayer interposed between the nickel layer and the surface layer.

29. The anode of embodiment 28, wherein the metal interlayer comprises copper.

30. The anode of embodiment 28 or 29, wherein the metal interlayer has an average interlayer thickness that is less than 50% of the total average thickness of the electrically conductive layer.

31. The anode according to any of embodiments 1 - 26, wherein the electrically conductive layer comprises copper.

32. The anode of embodiment 31, wherein the electrically conductive layer comprises a copper alloy comprising copper, magnesium, silver, and phosphorous.

33. The anode of embodiment 31, wherein the electrically conductive layer comprises a copper alloy comprising copper, iron, and phosphorous.

34. The anode of embodiment 31, wherein the electrically conductive layer comprises a copper alloy comprising brass or bronze.

35. The anode of embodiment 31, wherein the electrically conductive layer comprises a copper alloy comprising copper, nickel, and silicon.

36. The anode according to any of embodiments 1 - 35, wherein the electrically conductive layer comprises a mesh of electrically conductive carbon.

37. The anode according to any of embodiments 1 - 36, wherein the current collector further comprises an insulating substrate and the electrically conductive layer overlays the insulating substrate.

38. The anode according to any of embodiments 1 - 37, wherein the electrically conductive layer or current collector is characterized by a tensile strength of at least 500 MPa.

39. The anode according to any of embodiments 1 - 37, wherein the electrically conductive layer or current collector is characterized by a tensile strength of greater than 600 MPa.

40. The anode according to any of embodiments 1 - 37, wherein the electrically conductive layer or current collector is characterized by a tensile strength of at least 700 MPa.

41. The anode according to any of embodiments 1 - 40, wherein the electrically conductive layer comprises a roll-formed metal foil.

42. An anode for an energy storage device, the anode comprising:
a) a current collector comprising an electrically conductive layer and a surface layer disposed over the electrically conductive layer, the surface layer comprising a first surface sublayer and a second surface sublayer disposed over the first surface sublayer, wherein:
   (i) the first surface sublayer comprises a metal oxide,
   (ii) the second surface sublayer comprises silicon compound, wherein the silicon compound comprises, or is derived from, a siloxane, a siloxysilane, or a silazane, and
   (iii) the current collector is characterized by a surface roughness Ra ≥ 400 nm; and
b) a continuous porous lithium storage layer overlaying the surface layer, wherein the continuous porous lithium storage layer:
   (i) has an average thickness of at least 7 µm,
   (ii) comprises at least 40 atomic % silicon, germanium, or a combination thereof, and
   (iii) is substantially free of carbon-based binders.

43. The anode of embodiment 42, wherein the metal oxide comprises a transition metal.

44. The anode of embodiment 42, wherein the metal oxide comprises an oxide of titanium, vanadium, chromium, manganese, iron, cobalt, nickel, copper, zinc, molybdenum, tungsten, silver, zirconium, hafnium, tin, aluminum, indium, or niobium.

45. The anode of embodiment 42, wherein the metal oxide comprises at least a monolayer of an oxide of copper.

46. The anode of embodiment 42, wherein the second surface sublayer comprises 1 to 100 mg/m² of silicon from the silicon compound.

47. The anode according to any of embodiments 42 - 46, wherein the second surface sublayer further comprises a metal-oxygen compound, wherein the metal-oxygen compound comprises a transition metal other than copper.

48. The anode of embodiment 47, wherein the metal-oxygen compound comprises a metal oxide.

49. The anode of embodiment 47 or 48, wherein the metal-oxygen compound comprises an oxometallate.

50. The anode according to any of embodiments 47 - 49, wherein the transition metal of the metal-oxygen compound comprises titanium, vanadium, chromium, manganese, iron, cobalt, nickel, molybdenum, tungsten, zirconium, or niobium.

51. The anode according to any of embodiments 47 - 50, wherein the transition metal of the metal-oxygen compound comprises molybdenum.

52. The anode according to any of embodiments 42 - 51, wherein the electrically conductive layer comprises nickel in a nickel layer.

53. The anode of embodiment 52, wherein the electrically conductive layer further comprises a metal interlayer interposed between the nickel layer and the surface layer.

54. The anode of embodiment 53, wherein the metal interlayer comprises copper.

55. The anode of embodiment 52 or 53, wherein the metal interlayer has an average interlayer thickness that is less than 50% of the total average thickness of the electrically conductive layer.

56. The anode according to any of embodiments 42 - 51, wherein the electrically conductive layer comprises copper.

57. The anode of embodiment 56, wherein the electrically conductive layer comprises a copper alloy comprising copper, magnesium, silver, and phosphorous.

58. The anode of embodiment 56, wherein the electrically conductive layer comprises a copper alloy comprising copper, iron, and phosphorous.

59. The anode of embodiment 56, wherein the electrically conductive layer comprises a copper alloy comprising brass or bronze.

60. The anode of embodiment 56, wherein the electrically conductive layer comprises a copper alloy comprising copper, nickel, and silicon.

61. The anode according to any of embodiments 42 - 60, wherein the electrically conductive layer comprises a mesh of electrically conductive carbon.

62. The anode according to any of embodiments 42 - 61, wherein the current collector further comprises an insulating substrate and the electrically conductive layer overlays the insulating substrate.

63. The anode according to any of embodiments 42 - 62, wherein the electrically conductive layer or current collector is characterized by a tensile strength of at least 500 MPa.

64. The anode according to any of embodiments 42 - 62, wherein the electrically conductive layer or current collector is characterized by a tensile strength of greater than 600 MPa.

65. The anode according to any of embodiments 42 - 62, wherein the electrically conductive layer or current collector is characterized by a tensile strength of at least 700 MPa.

66. The anode according to any of embodiments 42 - 65, wherein the electrically conductive layer comprises a roll-formed metal foil.

67. The anode according to any of embodiments 42 - 66, wherein the silicon compound comprises, or is derived from a compound according to formula (1)

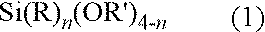

wherein, n = 1, 2, or 3, and R and R′ are independently selected substituted or unsubstituted alkyl, alkenyl, or aryl groups.

68. An anode for an energy storage device, the anode comprising:
a) a current collector comprising an electrically conductive layer and a surface layer disposed over the electrically conductive layer, the surface layer comprising at least a metal-oxygen compound comprising a transition metal, wherein:
   (i) the surface layer further comprises a silicon compound, zinc, or both a silicon compound and zinc,
   (ii) when the surface layer comprises zinc, the metal-oxygen compound comprises a transition metal other than zinc, and
   (iii) the current collector is characterized by a surface roughness Ra ≥ 250 nm; and
b) a continuous porous lithium storage layer overlaying the surface layer, wherein the continuous porous lithium storage layer:
   (i) has an average thickness of at least 7 µm,
   (ii) comprises at least 40 atomic % silicon, germanium, or a combination thereof, and
   (iii) is substantially free of carbon-based binders.

69. The anode of embodiment 68, wherein the surface layer comprises a mixture of the silicon compound and the metal-oxygen compound.

70. The anode of embodiment 68, wherein the surface layer comprises a first surface sublayer proximate the electrically conductive layer and a second surface sublayer disposed over the first surface sublayer.

71. The anode of embodiment 70, wherein the first surface sublayer comprises zinc and the second surface sublayer comprises the metal-oxygen compound.

72. The anode of embodiment 71, wherein the second surface sublayer further comprises the silicon compound.

73. The anode of embodiment 71, wherein the surface layer further comprises a third surface sublayer over the second surface sublayer, the third surface sublayer comprising the silicon compound.

74. The anode of embodiment 70, wherein the first surface sublayer comprises the metal-oxygen compound and the second surface sublayer comprises the silicon compound.

75. The anode of embodiment 74, wherein the metal-oxygen compound comprises a transition metal oxide.

76. The anode of embodiment 75, wherein the metal-oxygen compound comprises at least a monolayer of an oxide of copper.

77. The anode according to any of embodiments 68 - 76, wherein the silicon compound comprises, or is derived from, a siloxane, a siloxysilane, or a silazane.

78. The anode according to any of embodiments 1 - 77, further comprising one or more supplemental layers overlaying the continuous porous lithium storage layer.

79. The anode according to any of embodiments 1 — 78, wherein the continuous porous lithium storage layer is substantially free of lithium storage nanostructures.

80. The anode according to any of embodiments 1 - 79, wherein the continuous porous lithium storage layer comprises a sub-stoichiometric nitride of silicon.

81. The anode according to any of embodiments 1 - 79, wherein the continuous porous lithium storage layer comprises at least 80 atomic % of amorphous silicon.

82. The anode of embodiment 81, wherein the density of the continuous porous lithium storage layer is in a range of 1.1 to 2.25 g/cm³.

83. The anode according to any of embodiments 1 - 82, wherein the continuous porous lithium storage layer has an average thickness of at least 10 µm.

84. A lithium-ion battery comprising an anode according to any of embodiments 1 -83 and a cathode.

85. The lithium-ion battery of embodiment 84, wherein the anode is prelithiated.

86. The lithium-ion battery of embodiment 84 or 85, wherein the battery is characterized in operation by an initial charge capacity of at least 1.6 mAh/cm² and is capable of an 80% SoH cycle life of at least 150 cycles at a charge rate of at least 1C and a discharge rate of at least C/3.

87. The lithium-ion battery of embodiment 86, wherein the cycle life is at least 500 cycles.

88. The lithium-ion battery of embodiment 87, wherein the initial charge capacity is at least 3.0 mAh/cm².

89. The lithium-ion battery of embodiment 86, wherein the charge rate is at least 3C and the cycle life is at least 400 cycles.

90. The lithium-ion battery of embodiment 89, wherein the initial charge capacity is at least 2.0 mA/cm².

91. The lithium-ion battery of embodiment 90, wherein the cycle life is at least 500 cycles.

92. The lithium-ion battery according to any of embodiments 84 - 91, wherein the cathode comprises nickel, manganese, and cobalt.

93. The lithium-ion battery according to any of embodiments 84 - 91, wherein the cathode comprises sulfur, selenium, or both sulfur and selenium.

94. A lithium-ion battery comprising an anode and a cathode, wherein the anode is prepared in part by applying at least one electrochemical charge/discharge cycle to a non-cycled anode, the non-cycled anode comprising an anode according to any of embodiments 1 - 83.

95. A current collector for a lithium-ion storage device anode, the current collector comprising:
a) an electrically conductive layer; and
b) a plurality of nanopillar features disposed over the electrically conductive layer, the nanopillar features each being characterized by a height H, a base width B, and a maximum width W, wherein each of the plurality of nanopillar features comprises a copper-containing nanopillar core and a surface layer is at least partially over the copper-containing nanopillar core, wherein an average 20 µm long cross section of the current collector comprises:
   (i) at least five first-type nanopillars, each first-type nanopillar characterized by
      A) H in a range of 0.4 µm to 3.0 µm,
      B) B in a range of 0.2 µm to 1.0 µm,
      C) a W/B ratio in a range of 1 to 1.5,
      D) an H/B aspect ratio in a range of 0.8 to 4.0, and
      E) an angle of a longitudinal axis relative to the plane of the electrically conductive layer in a range of 60° to 90°; and
   (ii) fewer than four second-type nanopillars, each second-type nanopillar characterized by
      A) H of at least 1.0 µm, and
      B) a W/B ratio greater than 1.5.

96. The current collector of embodiment 95, wherein the surface layer comprises a first surface sublayer disposed over the copper-containing nanopillar cores and a second surface sublayer disposed over the first surface sublayer.

97. The current collector of embodiment 96, wherein:
(i) the first surface sublayer comprises zinc,
(ii) the second surface sublayer comprises a metal-oxygen compound, wherein the metal-oxygen compound comprises a transition metal other than zinc.

98. The current collector according to any of embodiments 95 - 97, wherein the average 20 µm long cross section comprises at least eight first-type nanopillars and fewer than three second-type nanopillars.

99. The current collector according to any of embodiments 95 - 98, wherein the electrically conductive layer comprises nickel in a nickel layer.

100 The current collector of embodiment 99, wherein the electrically conductive layer further comprises a metal interlayer interposed between the nickel layer and the surface layer.

101. The current collector of embodiment 100, wherein the metal interlayer comprises copper.

102. The current collector according to any of embodiments 95 - 98, wherein the electrically conductive layer comprises copper.

103. The current collector of embodiment 102, wherein the electrically conductive layer comprises a copper alloy comprising copper, magnesium, silver, and phosphorous.

104. The current collector of embodiment 102, wherein the electrically conductive layer comprises a copper alloy comprising copper, iron, and phosphorous.

105. The current collector of embodiment 102, wherein the electrically conductive layer comprises a copper alloy comprising brass or bronze.

106. The current collector of embodiment 102, wherein the electrically conductive layer comprises a copper alloy comprising copper, nickel, and silicon.

107. The current collector according to any of embodiments 95 - 106, wherein the electrically conductive layer or current collector is characterized by a tensile strength of at least 500 MPa.

108. The current collector according to any of embodiments 95 - 106, wherein the electrically conductive layer or current collector is characterized by a tensile strength of greater than 600 MPa.

109. The current collector according to any of embodiments 95 - 106, wherein the electrically conductive layer or current collector is characterized by a tensile strength of at least 700 MPa.

110. The current collector according to any of embodiments 95 - 109, wherein the electrically conductive layer comprises a roll-formed metal foil.

111. The current collector according to any of embodiments 95 - 110, wherein the surface layer is further disposed over the electrically conductive layer in interstitial areas between the nanopillar features.

112. The current collector according to any of embodiments 95 - 111, wherein the copper-containing nanopillar cores are formed by electrochemical deposition.

113. The current collector according to any of embodiments 96 - 112, wherein the first surface sublayer comprises at least 98 atomic % zinc relative to all metal atoms in the first surface sublayer.

114. The current collector according to any of embodiments 96 - 113, wherein the first surface sublayer comprises a zinc alloy.

115. The current collector of embodiment 114, wherein the first surface sublayer comprises less than 98 atomic % zinc relative to all metal atoms in the first surface sublayer.

116. The current collector of embodiment 114 or 115, wherein the zinc alloy comprises zinc and nickel.

117. The current collector of embodiment 116, wherein the first surface sublayer comprises 3 to 30 atomic % nickel.

118. The current collector according to any of embodiments 96 - 117, wherein the first surface sublayer comprises zinc in a range of 10 to 3000 mg/m².

119. The current collector of embodiment 113, wherein the first surface sublayer comprises zinc in a range of 10 to 100 mg/m².

120. The current collector according to any of embodiments 114 - 117, wherein the first surface sublayer comprises zinc in a range of 500 to 3000 mg/m².

121. The current collector according to any of embodiments 97 - 120, wherein the metal-oxygen compound comprises a metal oxide.

122. The current collector according to any of embodiments 97 - 121, wherein the metal-oxygen compound comprises an oxometallate.

123. The current collector according to any of embodiments 97 - 122, wherein the transition metal of the metal-oxygen compound comprises titanium, vanadium, chromium, manganese, iron, cobalt, nickel, molybdenum, tungsten, zirconium, or niobium.

124. The current collector according to any of embodiments 97 - 122, wherein the transition metal of the metal-oxygen compound comprises chromium.

125. The current collector of embodiment 124, wherein the second surface sublayer comprises chromium in a range of 2 to 50 mg/m².

126. A current collector for a lithium-ion storage device anode, the current collector comprising an electrically conductive layer and a surface layer disposed over the electrically conductive layer, the surface layer comprising a first surface sublayer and a second surface sublayer disposed over the first surface sublayer, wherein:
(i) the first surface sublayer comprises a metal oxide,
(ii) the second surface sublayer comprises silicon compound, wherein the silicon compound comprises, or is derived from, a siloxane, a siloxysilane, or a silazane, and
(iii) the current collector is characterized by a surface roughness Rₐ ≥ 400 nm.

127. The current collector of embodiment 126, wherein the metal oxide comprises a transition metal.

128. The current collector of embodiment 126, wherein the metal oxide comprises an oxide of titanium, vanadium, chromium, manganese, iron, cobalt, nickel, copper, zinc, molybdenum, tungsten, silver, zirconium, hafnium, tin, aluminum, indium, or niobium.

129. The current collector of embodiment 126, wherein the metal oxide comprises at least a monolayer of an oxide of copper.

130. The current collector according to any of embodiments 126 - 129, wherein the second surface sublayer comprises 1 to 100 mg/m² of silicon.

131. The current collector according to any of embodiments 126 - 130, wherein the second surface sublayer further comprises a metal-oxygen compound, wherein the metal-oxygen compound comprises a transition metal other than copper.

132. The current collector of embodiment 131, wherein the metal-oxygen compound comprises a metal oxide.

133. The current collector of embodiment 131 or 132, wherein the metal-oxygen compound comprises an oxometallate.

134. The current collector according to any of embodiments 131 - 133, wherein the transition metal of the metal-oxygen compound comprises titanium, vanadium, chromium, manganese, iron, cobalt, nickel, molybdenum, tungsten, zirconium, or niobium.

135. The current collector according to any of embodiments 131 - 133, wherein the transition metal of the metal-oxygen compound comprises molybdenum.

136. The current collector according to any of embodiments 126 - 135, wherein the electrically conductive layer comprises nickel in a nickel layer.

137. The current collector of embodiment 136, wherein the electrically conductive layer further comprises a metal interlayer interposed between the nickel layer and the surface layer.

138. The current collector of embodiment 137, wherein the metal interlayer comprises copper.

139. The current collector of according to any of embodiments 136 - 138, wherein the metal interlayer has an average interlayer thickness that is less than 50% of the total average thickness of the electrically conductive layer.

140. The current collector according to any of embodiments 126 - 135, wherein the electrically conductive layer comprises copper.

141. The current collector of embodiment 140, wherein the electrically conductive layer comprises a copper alloy comprising copper, magnesium, silver, and phosphorous.

142. The current collector of embodiment 140, wherein the electrically conductive layer comprises a copper alloy comprising copper, iron, and phosphorous.

143. The current collector of embodiment 140, wherein the electrically conductive layer comprises a copper alloy comprising brass or bronze.

144. The current collector of embodiment 140, wherein the electrically conductive layer comprises a copper alloy comprising copper, nickel, and silicon.

145. The current collector according to any of embodiments 126 - 144, wherein the electrically conductive layer or current collector is characterized by a tensile strength of at least 500 MPa.

146. The current collector according to any of embodiments 126 - 144, wherein the electrically conductive layer or current collector is characterized by a tensile strength of greater than 600 MPa.

147. The current collector according to any of embodiments 126 - 144, wherein the electrically conductive layer or current collector is characterized by a tensile strength of at least 700 MPa.

148. The current collector according to any of embodiments 126 - 147, wherein the electrically conductive layer comprises a roll-formed metal foil.

149. The current collector according to any of embodiments 121 - 143, wherein the silicon compound comprises, or is derived from a compound according to formula (1)

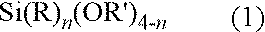

wherein, n = 1, 2, or 3, and R and R′ are independently selected substituted or unsubstituted alkyl, alkenyl, or aryl groups.

150. The current collector according to any of embodiments 126 - 149, wherein the surface of the current collector is characterized by pits.

151. The current collector of embodiment 150 wherein the pits are formed by chemical roughing using a chemical etching agent.

152. The current collector according to any of embodiments 126 - 151, wherein the current collector is characterized by a surface roughness Ra ≥ 550 nm.

153. An anode for a lithium-ion energy storage device, the anode comprising a current collector according to any of embodiments 95 - 152 and a lithium storage layer disposed over the current collector.

154. The anode of embodiment 153, wherein the lithium storage layer comprises silicon.

155. The anode of embodiment 153 or 154, wherein the lithium storage layer comprises at least 40 atomic % silicon, germanium, or a combination thereof.

156. The anode according to any of embodiment 153 - 155, wherein the lithium storage layer further comprises a carbon-based binder.

157. The anode according to any of embodiment 153 - 155, wherein the lithium storage layer is substantially free of carbon-based binders.

158. The anode of embodiment 157, wherein lithium storage layer comprises a sub-stoichiometric nitride of silicon.

159. The anode of embodiment 157, wherein the lithium storage layer comprises at least 80 atomic % amorphous silicon and has a density in a range of 1.2 to 2.25 g/cm³.

160. The anode according to any of embodiments 157 - 159, wherein the lithium storage layer is a continuous porous lithium storage layer.

161. The anode according to any of embodiments 157 - 160, wherein the lithium storage layer is deposited by a PECVD process.

162. A method of making a current collector for use in an energy storage device, the method comprising:
chemically roughening a surface of an electrically conductive layer comprising copper by treatment with a chemical etching agent to form a roughened electrically conductive layer; and
forming a surface layer over the electrically conducive layer by contacting the roughened electrically conductive layer with a silicon compound agent comprising a siloxane, a siloxysilane, or a silane, the surface layer comprising a silicon compound comprising or derived from the silicon compound agent. wherein:
   (i) the current collector is characterized by a surface roughness Ra ≥ 400 nm,
   (ii) chemical roughening does not comprise electrodeposition, and
   (iii) forming the surface layer does not comprise electrodeposition

163. The method of embodiment 162, wherein the silicon compound agent is provided in a solution or as a vapor.

164. The method of embodiment 162 or 163, further comprising heating the roughened electrically conductive layer after contacting with the silicon compound agent to a temperature of at least 100° C.

165. The method according to any of embodiments 162 - 164, wherein the silicon compound agent comprises a compound according to formula (1)

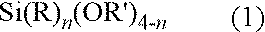

wherein, n = 1, 2, or 3, and R and R′ are independently selected substituted or unsubstituted alkyl, alkenyl, or aryl groups.

166. The method according to any of embodiments 162 - 165, wherein the silicon compound agent is provided in a solution, the solution further comprising a metal-oxygen compound, wherein the metal-oxygen compound comprises a transition metal.

167. The method of embodiment 166, wherein the metal-oxygen compound comprises a oxometallate.

168. The method of embodiment 166 or 167, wherein the transition metal of the metal-oxygen compound comprises titanium, vanadium, chromium, manganese, iron, cobalt, nickel, molybdenum, tungsten, zirconium, or niobium.

169. The method of embodiment 166 or 167, wherein the transition metal of the metal-oxygen compound comprises molybdenum.

170. The method according to any of embodiment 162 - 169, wherein forming the surface layer further comprises forming a first surface sublayer proximate the roughened electrically conductive layer and forming a second surface sublayer over the first surface sublayer.

171. The method according to embodiment 170, wherein the first surface sublayer comprises a metal oxide and the second surface sublayer comprises the silicon compound.

172. The method of embodiment 171, wherein the metal oxide comprises a transition metal.

173. The method of embodiment 171, wherein the metal oxide comprises an oxide of titanium, vanadium, chromium, manganese, iron, cobalt, nickel, copper, zinc, molybdenum, tungsten, silver, zirconium, hafnium, tin, aluminum, indium, or niobium.

174. The method of embodiment 171, wherein the metal oxide comprises at least a monolayer of an oxide of copper.

175. The method according to any of embodiments 162 - 174, wherein the chemical etching agent comprises an oxidant.

176. The method according to any of embodiments 162 - 175, wherein the chemical etching agent comprises an organic acid.

177. The method according to any of embodiments 162 - 176, further comprising etching a plurality of pits into the surface of the electrically conductive layer.

178. A current collector for a lithium-ion storage device anode, the current collector comprising an electrically conductive layer and a surface layer disposed over the electrically conductive layer, the surface layer comprising a first surface sublayer proximate the electrically conductive layer and a second surface sublayer disposed over the first surface sublayer, wherein:
(i) the first surface sublayer comprises zinc,
(ii) the second surface sublayer comprises a metal-oxygen compound, wherein the metal-oxygen compound comprises a transition metal other than zinc, and
(iii) the current collector is characterized by a surface roughness Rₐ ≥ 250 nm.

179. The current collector of embodiment 178, wherein the surface layer further comprises a third surface sublayer provided over the second surface sublayer, the third surface sublayer comprising a silicon compound.

180. The current collector of embodiment 179, wherein the silicon compound comprises, or is derived from, a siloxane, a siloxysilane, or a silazane.

181. The current collector of embodiment 179, wherein the silicon compound comprises, or is derived from a compound according to formula (1)

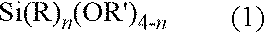

wherein, n = 1, 2, or 3, and R and R′ are independently selected substituted or unsubstituted alkyl, alkenyl, or aryl groups.

182. The current collector according to any of embodiments 179 - 181, wherein the surface layer further comprises a fourth surface sublayer provided over the third surface sublayer, the fourth surface sublayer comprising a metal oxide.

183. The current collector of embodiment 182, wherein the metal oxide is a transition metal oxide.

184. The current collector of embodiment 182, wherein the metal oxide comprises an oxide of titanium, vanadium, chromium, manganese, iron, cobalt, nickel, copper, zinc, molybdenum, tungsten, silver, zirconium, hafnium, tin, aluminum, indium, or niobium.

185. The current collector of embodiment 178, wherein the surface layer does not include a silicon compound.

186. The current collector of embodiment 178 or 185, wherein the surface layer further comprises a third surface sublayer provided over the second surface sublayer, the third surface sublayer comprising a metal oxide.

187. The current collector of embodiment 186, wherein the metal oxide is a transition metal oxide.

188. The current collector of embodiment 186, wherein the metal oxide comprises an oxide of titanium, vanadium, chromium, manganese, iron, cobalt, nickel, copper, zinc, molybdenum, tungsten, silver, zirconium, hafnium, tin, aluminum, indium, or niobium.

187. The current collector according to any of embodiments 178 - 188, wherein the first surface sublayer comprises at least 98 atomic % zinc relative to all metal atoms in the first surface sublayer.

188. The current collector according to any of embodiments 178 - 188, wherein the first surface sublayer comprises a zinc alloy.

189. The current collector of embodiment 188, wherein the first surface sublayer comprises less than 98 atomic % zinc relative to all metal atoms in the first surface sublayer.

190. The current collector of embodiment 188 or 189, wherein the zinc alloy comprises zinc and nickel.

191. The current collector of embodiment 190, wherein the first surface sublayer comprises 3 to 30 atomic % nickel.

192. The current collector according to any of embodiments 178 - 191, wherein the first surface sublayer comprises zinc in a range of 10 to 3000 mg/m².

193. The current collector of embodiment 187, wherein the first surface sublayer comprises zinc in a range of 10 to 100 mg/m².

194. The current collector according to any of embodiments 188 - 191, wherein the first surface sublayer comprises zinc in a range of 500 to 3000 mg/m².

195. The current collector according to any of embodiments 178 - 194, wherein the metal-oxygen compound comprises a metal oxide.

196. The current collector according to any of embodiments 178 - 195, wherein the metal-oxygen compound comprises an oxometallate.

197. The current collector according to any of embodiments 178 - 196, wherein the transition metal of the metal-oxygen compound comprises titanium, vanadium, chromium, manganese, iron, cobalt, nickel, molybdenum, tungsten, zirconium, or niobium.

198. The current collector according to any of embodiments 178 - 196, wherein the transition metal of the metal-oxygen compound comprises chromium.

199. The current collector of embodiment 198, wherein the second surface sublayer comprises chromium in a range of 2 to 50 mg/m².

200. The current collector according to any of embodiments 178 - 199, wherein the electrically conductive layer comprises nickel in a nickel layer.

201. The current collector of embodiment 200, wherein the electrically conductive layer further comprises a metal interlayer interposed between the nickel layer and the surface layer.

202. The current collector of embodiment 201, wherein the metal interlayer comprises copper.

203. The current collector of embodiment 201 or 202, wherein the metal interlayer has an average interlayer thickness that is less than 50% of the total average thickness of the electrically conductive layer.

204. The current collector according to any of embodiments 178 - 199, wherein the electrically conductive layer comprises copper.

205. The current collector of embodiment 204, wherein the electrically conductive layer comprises a copper alloy comprising copper, magnesium, silver, and phosphorous.

206. The current collector of embodiment 204, wherein the electrically conductive layer comprises a copper alloy comprising copper, iron, and phosphorous.

207. The current collector of embodiment 204, wherein the electrically conductive layer comprises a copper alloy comprising brass or bronze.

208. The current collector of embodiment 204, wherein the electrically conductive layer comprises a copper alloy comprising copper, nickel, and silicon.

209. The current collector according to any of embodiments 178 - 208, wherein the electrically conductive layer or current collector is characterized by a tensile strength of at least 500 MPa.

210. The current collector according to any of embodiments 178 - 208, wherein the electrically conductive layer or current collector is characterized by a tensile strength of greater than 600 MPa.

211. The current collector according to any of embodiments 178 - 208, wherein the electrically conductive layer or current collector is characterized by a tensile strength of at least 700 MPa.

212. The current collector according to any of embodiments 178 - 211, wherein the electrically conductive layer comprises a roll-formed metal foil.

213. A method of making an anode for use in an energy storage device, the method comprising:
providing a current collector according to any of embodiments 95 - 152 or 178 - 212, or made by a method according to any of embodiments 162 - 177; and
forming, by chemical vapor deposition using a silane-containing gas, a lithium storage layer disposed over the current collector.

214. The method of embodiment 213, wherein the chemical vapor deposition comprises a PECVD process.

215. The method of embodiment 214, wherein the PECVD process comprises forming a capacitively-coupled plasma or an inductively-coupled plasma.

216. The method of embodiment 214, wherein the PECVD process comprises a DC plasma source, an AC plasma source, an RF plasma source, a VHF plasma source, or a microwave plasma source.

217. The method of embodiment 214, wherein the PECVD process comprises magnetron-assisted RF PECVD.

218. The method of embodiment 214, wherein the PECVD process comprises expanding thermal plasma chemical vapor deposition.

219. The method of embodiment 214, wherein the PECVD process comprises hollow cathode PECVD.

220. The method according to any of embodiments 213 - 219, wherein the lithium storage layer comprises at least 40 atomic % silicon, germanium, or a combination thereof.

221. The method according to any of embodiments 213 - 220, wherein the lithium storage layer includes less than 10 atomic % carbon.

222. The method according to any of embodiments 213 - 221, wherein the lithium storage layer is substantially free of lithium storage nanostructures.

223. The method according to any of embodiments 213 - 222, wherein the lithium storage layer is a continuous porous lithium storage layer.

224. The method according to any of embodiments 213 - 223, wherein the lithium storage layer comprises a sub-stoichiometric nitride of silicon.

225. The method according to any of embodiments 213 - 224, wherein the lithium storage layer comprises a sub-stoichiometric oxide of silicon.

226. The method according to any of embodiments 213 - 225, wherein the lithium storage layer comprises at least 80 atomic % of amorphous silicon.

227. The method of embodiment 226, wherein the density of the lithium storage layer is in a range of 1.1 to 2.25 g/cm³.

228. The method according to any of embodiments 213 - 225, wherein the lithium storage layer comprises up to 30% of nano-crystalline silicon.

229. The method according to any of embodiments 213 — 228, wherein the lithium storage layer comprises columns of silicon nanoparticle aggregates.

230. The method according to any of embodiments 213 - 229, wherein the lithium storage layer has an average thickness of at least 7 µm.

231. The method according to any of embodiments 213 - 230, wherein the silane-containing gas is silane.

232. The method according to any of embodiments 213 - 231, further comprising adding hydrogen gas during the chemical vapor deposition, wherein the ratio of the silane-containing gas to the hydrogen gas is 2 or less.

233. The method according to any of embodiments 213 - 232, further comprising doping the lithium storage layer with boron, phosphorous, sulfur, fluorine, aluminum, gallium, indium, arsenic, antimony, or bismuth, or a combination thereof.

234. A method of making a prelithiated anode, the method comprising
i) providing an anode according to any of embodiments 1 - 83 or 153 - 161, or an anode made according to any of embodiments 213 - 232; and
ii) incorporating lithium into the lithium storage layer of the anode to fill at least 5% of the lithium storage capacity, thereby forming the prelithiated anode.

235. The method of embodiment 234, further comprising depositing lithium metal over the lithium storage layer.

236. The method of embodiment 234, further comprising contacting the lithium storage layer with a reductive lithium organic compound.

237. The method of embodiment 234, further comprising electrochemically reducing lithium ion at the anode in a prelithiation solution.

The specific details of particular embodiments may be combined in any suitable manner without departing from the spirit and scope of embodiments of the invention. However, other embodiments of the invention may be directed to specific embodiments relating to each individual aspect, or specific combinations of these individual aspects.

The above description of example embodiments of the invention has been presented for the purposes of illustration and description. It is not intended to be exhaustive or to limit the invention to the precise form described, and many modifications and variations are possible in light of the teaching above.

In the preceding description, for the purposes of explanation, numerous details have been set forth in order to provide an understanding of various embodiments of the present technology. It will be apparent to one skilled in the art, however, that certain embodiments may be practiced without some of these details, or with additional details.

Having described several embodiments, it will be recognized by those of skill in the art that various modifications, alternative constructions, and equivalents may be used without departing from the spirit of the invention. Additionally, a number of well-known processes and elements have not been described in order to avoid unnecessarily obscuring the present invention. Additionally, details of any specific embodiment may not always be present in variations of that embodiment or may be added to other embodiments.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed. The upper and lower limits of these smaller ranges may independently be included or excluded in the range, and each range where either, neither, or both limits are included in the smaller ranges is also encompassed within the invention, subject to any specifically excluded limit in the stated range. Where the stated range includes one or both of the limits, ranges excluding either or both of those included limits are also included.

As used herein and in the appended claims, the singular forms “a”, “an”, and “the” include plural referents unless the context clearly dictates otherwise. Thus, for example, reference to “a method” includes a plurality of such methods and reference to “the anode” includes reference to one or more anodes and equivalents thereof known to those skilled in the art, and so forth. The invention has now been described in detail for the purposes of clarity and understanding. However, it will be appreciated that certain changes and modifications may be practice within the scope of the appended claims.

What is claimed is:

1. An anode for an energy storage device, the anode comprising:
a) a current collector comprising an electrically conductive layer and a surface layer disposed over the electrically conductive layer, the surface layer comprising a first surface sublayer proximate the electrically conductive layer and a second surface sublayer disposed over the first surface sublayer, wherein:
(i) the first surface sublayer comprises zinc,
(ii) the second surface sublayer comprises a metal-oxygen compound, wherein the metal-oxygen compound comprises a transition metal other than zinc, and
(iii) the current collector is characterized by a surface roughness Rₐ ≥ 250 nm; and
b) a continuous porous lithium storage layer overlaying the surface layer, wherein the continuous porous lithium storage layer:
(i) has an average thickness of at least 2.5 µm,
(ii) comprises at least 40 atomic % silicon, germanium, or a combination thereof, and
(iii) is substantially free of carbon-based binders.

2. The anode of claim 1, wherein:
the surface layer further comprises a third surface sublayer provided over the second surface sublayer, the third surface sublayer comprising a silicon compound, and
the silicon compound comprises, or is derived from, a siloxane, a siloxysilane, or a silazane.

3-10. (canceled)

11. The anode of claim 1, wherein the first surface sublayer comprises at least 98 atomic % zinc relative to all metal atoms in the first surface sublayer.

12. The anode of claim 1, wherein the first surface sublayer comprises a zinc alloy.

13. (canceled)

14. The anode of claim 12, wherein the zinc alloy comprises zinc and nickel.

15-18. (canceled)

19. The anode of claim 1, wherein the metal-oxygen compound comprises a metal oxide.

20. The anode of claim 1, wherein the metal-oxygen compound comprises an oxometallate.

21. The anode of claim 1, wherein the transition metal of the metal-oxygen compound comprises titanium, vanadium, chromium, manganese, iron, cobalt, nickel, molybdenum, tungsten, zirconium, or niobium.

22-23. (canceled)

24. The anode of claim 1, wherein the current collector further comprises a plurality of nanopillar features disposed over the electrically conductive layer, wherein each of the plurality of nanopillar features comprises a copper-containing nanopillar core and the surface layer is at least partially over the copper-containing nanopillar core.

25. The anode of claim 24, wherein the nanopillar features are each characterized by a height H, a base width B, and a maximum width W, and
wherein an average 20 µm long cross section of the current collector comprises:
(i) at least five first-type nanopillars, each first-type nanopillar characterized by
A) H in a range of 0.4 µm to 3.0 µm,
B) B in a range of 0.2 µm to 1.0 µm,
C) a W/B ratio in a range of 1 to 1.5,
D) an H/B aspect ratio in a range of 0.8 to 4.0, and
E) an angle of a longitudinal axis relative to the plane of the electrically conductive layer in a range of 60° to 90°; and
(ii) fewer than four second-type nanopillars, each second-type nanopillar characterized by
A) H of at least 1.0 µm, and
B) a W/B ratio greater than 1.5.

26. (canceled)

27. The anode of claim 1, wherein the electrically conductive layer comprises nickel in a nickel layer.

28. The anode of claim 27, wherein;
the electrically conductive layer further comprises a metal interlayer interposed between the nickel layer and the surface layer, and
the metal interlayer comprises copper.

29-30. (canceled)

31. The anode of claim 1, wherein the electrically conductive layer comprises copper.

32-34. (canceled)

35. The anode of claim 31, wherein the electrically conductive layer comprises a copper alloy comprising copper, nickel, and silicon.

36. The anode of claim 1, wherein the electrically conductive layer comprises a mesh of electrically conductive carbon.

37-38. (canceled)

39. The anode of claim 1, wherein the electrically conductive layer or current collector is characterized by a tensile strength of greater than 600 MPa.

40-43. (canceled)

44. The anode of claim 1, wherein the continuous porous lithium storage layer comprises at least 80 atomic % of amorphous silicon.

45. The anode of claim 44, wherein the density of the continuous porous lithium storage layer is in a range of 1.1 to 2.25 g/cm³.

46-47. (canceled)

48. A lithium-ion battery comprising the anode of claim 1.
